(19) United States
(12) Patent Application Publication
(10) Pub. No.: US 2015/0186820 A1
(43) Pub. Date: Jul. 2, 2015

(54) DIVERSITY REPORTING SYSTEM AND METHOD

(71) Applicant: ConnXus, Inc., Mason, OH (US)

(72) Inventors: Henry Roderick Robinson, Mason, OH (US); Anthony Marvin Mitchell, West Chester, OH (US); Tyler James Johnson, Milford, OH (US); Timothy Mercer Scruta, Cincinnati, OH (US); Ljillauna Watson McCauley, Milford, OH (US); Erika Renee Sandman, Cincinnati, OH (US); Charlie Clay Peck, III, Miamisburg, OH (US)

(21) Appl. No.: 14/658,815

(22) Filed: Mar. 16, 2015

Related U.S. Application Data
(63) Continuation-in-part of application No. 14/039,960, filed on Sep. 27, 2013.

(51) Int. Cl. G06Q 10/06

(52) U.S. Cl. CPC G06Q 10/0637

(57) ABSTRACT

Included are systems and methods for determining diversity spend credit for parties in a supply chain. The systems and methods can include receiving diversity spend data for parties in the supply chain and iteratively determining, for each party in the supply chain, an amount of diversity spend credit that is directly or indirectly attributable, through the supply chain, to the purchase of goods or services from a diverse party in the supply chain, which can include multiple parties that buy or sell a good or service to one another. The diversity spend credit can be determined in real time as each party reports diversity spend data, and alerts or reports can be generated if threshold diversity levels for one or multiple diversity categories are crossed. The systems and methods can include generating alternative suppliers to meet diversity objectives.

### REFERENCE TO RELATED APPLICATIONS

This application is a continuation-in-part of U.S. patent application Ser. No. 14/039,960 filed on Sep. 27, 2013 which claims priority to U.S. Provisional Patent Application No. 61/706,386 filed on Sep. 27, 2012.

### TECHNICAL FIELD

Embodiments provided herein generally relate to methods of determining diversity spending and particularly to methods for determining diversity spend credit for parties in a supply chain and checking diversity spend data reported by suppliers.

### BACKGROUND

Currently, many companies are striving to achieve greater diversity among their employees. This quest for diversity may include employing a diverse workforce and contracting with diverse suppliers. However, oftentimes the suppliers (tier-1 suppliers) with whom the company contracts may subcontract their tasks to other suppliers (tier-2 suppliers). As such, the company may not know whether these other suppliers are diverse and thus whether the target diversity is achieved.

### SUMMARY OF THE INVENTION

Included are embodiments for determining diversity credits for parties in a supply chain. Some embodiments include receiving diversity spend data for parties in a supply chain that include a diverse supplier of goods or services, and iteratively determining for each party in the supply chain an amount of diversity spend credit for each party that is directly or indirectly attributable, through the supply chain, to the purchase of goods or services from the diverse supplier. In embodiments the diversity spend credit can be determined in real time as parties report their diversity spend data. A supply chain can include three or more parties, including the diverse supplier.

Also included are embodiments for checking diversity spend data reported by a supplier of a good or service. Such embodiments include receiving from a supplier a first set of diversity spend data attributable to a first buyer and a second set of diversity spend data attributable to a second buyer, comparing at least a portion of the first and second set of diversity spend data, and determining an inconsistency between the first and second set of diversity spend data. In embodiments, one or more of the parties can be queried regarding the inconsistency, and corrected diversity spend data can be received from one of the parties.

Also included are embodiments of a system that includes one or several processor configured to receive diversity spend data from one or more suppliers, and process the diversity spend data to determine an amount of diversity spend credit in one or multiple diversity categories based at least on amounts spend by a buyer with the suppliers, where the diversity spend credit is further attributable to either a plurality of jurisdictions of the buyer, stores of the buyer, or the suppliers. The processors are configured to generate a heat map based on selected diversity categories, the diversity spend credit attributable to each of the jurisdictions, stores, or the suppliers, and the geographic location of each of the jurisdictions, stores, or the suppliers. The system can include a display for presenting the heat map.

Also included are embodiments of a non-transitory computer readable medium having instructions stored thereon that when executed by one or more processors cause the processors to receive diversity spend data for parties in the supply chain that includes a diverse supplier of goods or services, and determining for each party in the supply chain an amount of diversity spend credit for each party that is directly or indirectly attributable, through the supply chain, to the purchase of goods or services from the diverse supplier. The diversity spend credit can be updated for each party in real time, and aggregated in real time with other diversity spend credit, as the diversity spend data is received from parties in the supply chain. In embodiments, if the diversity spend data of a buyer is determined to cross threshold level, an alert or diversity spend report can be generated and sent to the buyer. In embodiments, a list of alternative suppliers can be generated that can increase the diversity spend data of the buyer above the threshold level or diversify the suppliers. In embodiments, the threshold level can be determined for a particular diversity category in the buyer's diversity spend data.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment for providing a tier-2 diversity reporting tool, according to one or more embodiments shown and described herein;

FIG. 2 depicts a remote computing device for providing the tier-2 diversity reporting tool, according to one or more embodiments shown and described herein;

FIG. 3 depicts a user interface for a buyer to create a report and manage primes, according to one or more embodiments shown and described herein;

FIG. 4 depicts a user interface for viewing a list of one or more primes who have accepted an invitation to report tier-2 spending, according to one or more embodiments shown and described herein;

FIG. 5 depicts a user interface for inviting additional primes to report tier-2 spending, according to one or more embodiments shown and described herein;

FIG. 6 depicts a user interface for granting access to a prime, according to one or more embodiments shown and described herein;

FIG. 7 depicts a user interface for setting up a new report of tier-2 spending, according to one or more embodiments shown and described herein;

FIG. 8 depicts a user interface for viewing and editing reporting periods for tier-2 spending, according to one or more embodiments shown and described herein;

FIG. 9 depicts a user interface for adding an additional reporting period for tier-2 spending, according to one or more embodiments shown and described herein;

FIG. 10 depicts a user interface for deleting a reporting period for tier-2 spending, according to one or more embodiments shown and described herein;

FIG. 11 depicts a user interface for setting up reporting jurisdictions of tier-2 reporting, according to one or more embodiments shown and described herein;

FIG. 12 depicts a user interface for adding an additional reporting jurisdiction for tier-2 spending, according to one or more embodiments shown and described herein;

FIG. 13 depicts a user interface for deleting a reporting jurisdiction for tier-2 spending, according to one or more embodiments shown and described herein;

FIG. 14 depicts a user interface for activating a report of tier-2 spending, according to one or more embodiments shown and described herein;

FIG. 15 depicts a user interface for deleting a report, according to one or more embodiments shown and described herein;

FIG. 16 depicts a user interface for finalizing a report, according to one or more embodiments shown and described herein;

FIG. 17 depicts a user interface for providing a tier-2 report, according to one or more embodiments shown and described herein;

FIG. 18 depicts a first quarter tier-2 report, according to one or more embodiments shown and described herein;

FIG. 19 depicts user interface for providing a first quarter summary report of direct spending and indirect spending, according to one or more embodiments shown and described herein;

FIG. 20 depicts a user interface for a prime to add tier-2 suppliers to the prime account, according to one or more embodiments shown and described herein;

FIG. 21 depicts a user interface for providing a prime with a list of reports setup by a buyer of the prime, according to one or more embodiments shown and described herein;

FIG. 22 depicts a user interface for providing a tier-2 submission for a report, according to one or more embodiments shown and described herein;

FIG. 23 depicts a user interface for a prime to submit a draft report of tier-2 diversity spending, according to one or more embodiments shown and described herein;

FIG. 24 depicts a user interface for viewing and editing direct expenditures by a prime, according to one or more embodiments shown and described herein;

FIG. 25 depicts a user interface for a prime to add a direct expenditure, according to one or more embodiments shown and described herein;

FIG. 26 depicts a user interface for a prime to delete a direct expenditure, according to one or more embodiments shown and described herein;

FIG. 27 depicts a user interface for a prime to view and submit a report to a buyer, according to one or more embodiments shown and described herein;

FIG. 28 depicts a user interface for a prime to view a quarterly summary report for a buyer, according to one or more embodiments shown and described herein;

FIG. 29 depicts a flowchart for a buyer to create and view reports of tier-2 spending, according to one or more embodiments shown and described herein;

FIG. 30 depicts a flowchart for a prime to provide expenditures for tier-2 spending, according to one or more embodiments shown and described herein;

FIG. 31 depicts a flowchart for providing diversity data, according to embodiments disclosed herein;

FIG. 32 depicts a user interface for displaying a heat map of diversity spending by jurisdiction, according to embodiments disclosed herein;

FIG. 33 depicts a user interface for displaying heat map of diversity spending by prime supplier, according to embodiments disclosed herein;

FIG. 34 depicts a flowchart for providing supplier recommendations, diversity alerts, threshold reporting, and benchmarking, according to embodiments disclosed herein; and

FIG. 35 depicts a flowchart for diversity checking and diversity crediting across a supply chain, according to embodiments disclosed herein.

### DETAILED DESCRIPTION

Various non-limiting embodiments of the present disclosure will now be described to provide an overall understanding of the principles of the structure, function, and use of diversity reporting systems and methods disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Embodiments disclosed herein may be configured for buying companies (buyers) to easily track their tier-2 spending with diverse suppliers. Specifically, the embodiments may be configured as a web (cloud) based, interactive platform that is designed around “ease of use.” The buyer creates an online account and invites their tier-1 suppliers (“primes” or “prime suppliers”) to create their own accounts. The buyer account is linked to the prime accounts, which allows at least one prime supplier to enter sales data and other diversity spend data relative to the buyer. Embodiments disclosed herein track both direct and indirect spending. The buyer can create a variety of custom reports and download to local storage, as desired. Embodiments disclosed herein are “community based” in that each prime and buyer only creates one account, but either can report data to or request data from any prime or buyer in the community.

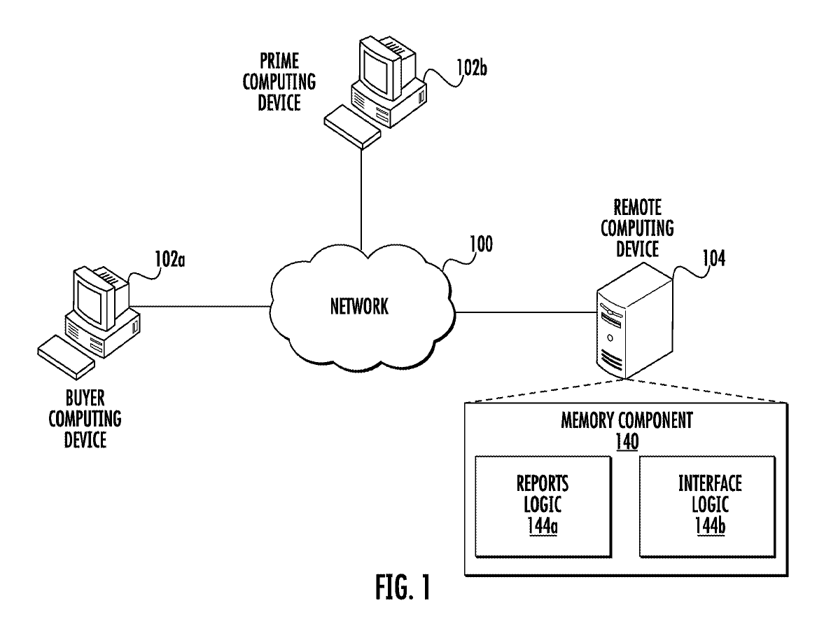

Referring now to the drawings, FIG. 1 depicts a computing environment for providing a tier-2 reporting tool, according to one or more embodiments shown and described herein. As illustrated, a network 100 may be coupled to a buyer computing device 102 a, a prime computing device 102 b, and a remote computing device 104. The network 100 may include any wide area and/or local area network, such as the internet, a mobile communications network, a satellite network, a public service telephone network (PSTN) and/or other network for facilitating communication between devices. If the network 100 includes a local area network, the local area network may be configured as a corporate network, school network, and/or other open or closed network that is coupled to a wide area network.

Accordingly, the buyer computing device 102 a and the prime computing device 102 b may each be configured as a personal computer, laptop computer, tablet, mobile computing device, mobile communications device, database, and/or other computing device operated by a buyer and/or vendor, respectively.

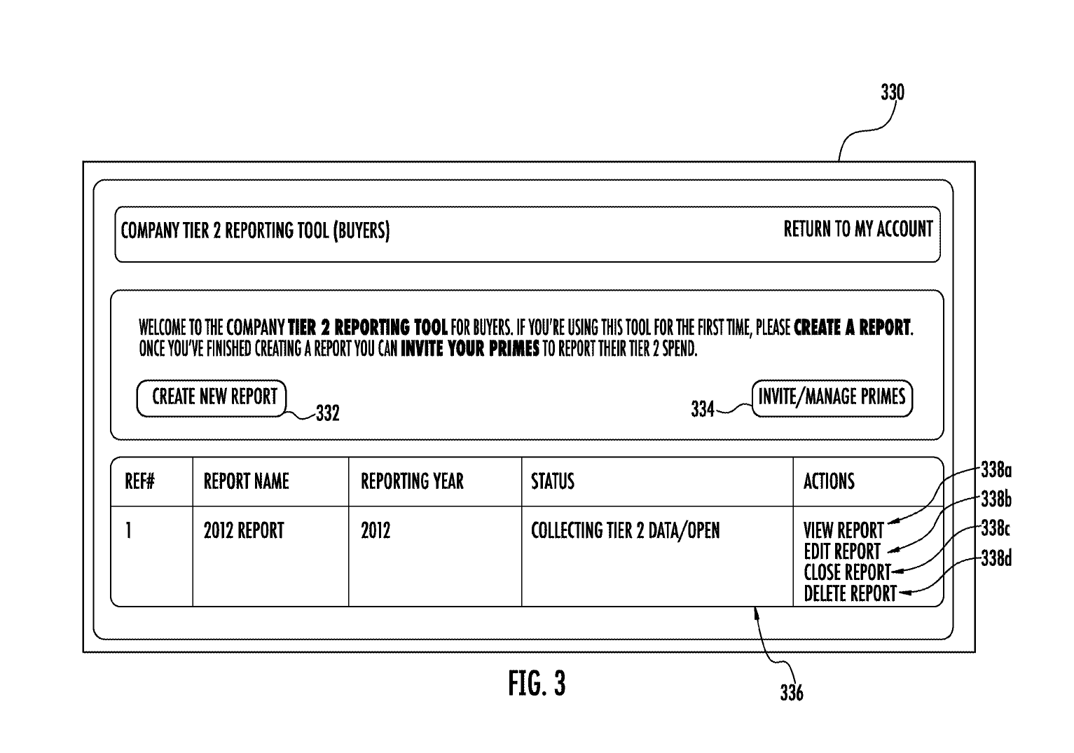

The remote computing device 104 may be configured to generate reports according to the data provided by the buyer and prime and provide user interfaces, such as those depicted in FIGS. 3-28. The remote computing device 104 may be configured as any type of computing device that is designed and operates to operate with the described functionality. Accordingly, the remote computing device 104 includes a memory component 140, which stores reports logic 144 a and interface logic 144 b. The reports logic 144 a may be configured to receive data from the buyer and the prime and generate reports regarding tier-2 spending. The interface logic 144 b may cause the buyer computing device 102 a and/or the prime computing device 102 b to provide one or more user interfaces, such as those depicted in FIGS. 3-28.

It should be understood that while the buyer computing device 102 a and the prime computing device 102 b are depicted as single personal computers and the remote computing device 104 is depicted as a single server, these are merely examples. Any of these devices may include one or more personal computers, servers, laptops, tablets, mobile computing devices, data storage devices, etc. that are configured for providing information to a user as described herein.

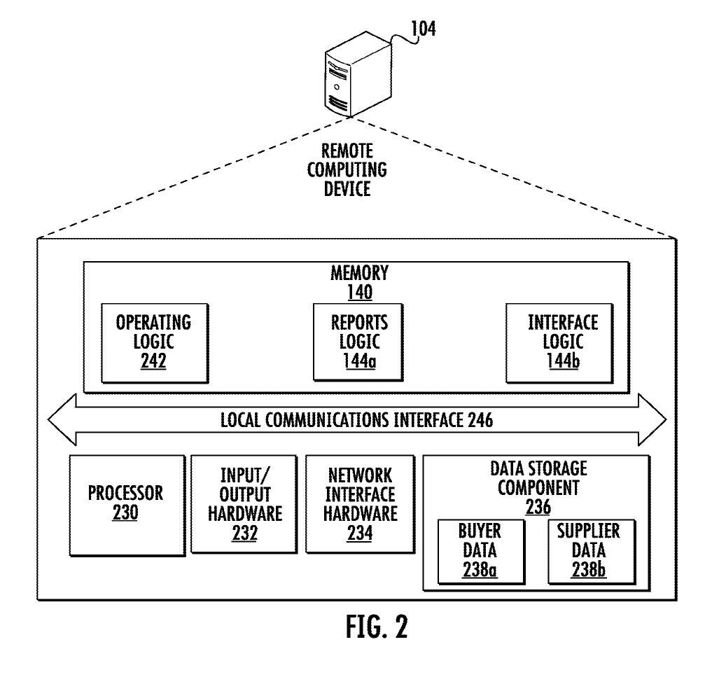

FIG. 2 depicts a remote computing device 104 for providing the tier-2 reporting tool, according to one or more embodiments shown and described herein. In the illustrated embodiment, the remote computing device 104 includes a processor 230, input/output hardware 232, network interface hardware 234, a data storage component 236 (which stores buyer data 238 a and supplier data 238 b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, the non-transitory computer-readable medium may reside within the remote computing device 104 and/or external to the remote computing device 104.

Additionally, the memory component 140 may be configured to store operating logic 242, the reports logic 144 a, and the interface logic 144 b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

Similarly, it should be understood that the data storage component 236 may reside local to and/or remote from the remote computing device 104 and may be configured to store one or more pieces of data for access by the remote computing device 104 and/or other components. In some embodiments, the data storage component 236 may be located remotely from the remote computing device 104 and thus accessible via the network 100. In some embodiments however, the data storage component 236 may merely be a peripheral device, but external to the remote computing device 104.

Included in the memory component 140 are the operating logic 242, the reports logic 144 a, and the interface logic 144 b. The operating logic 242 may include an operating system and/or other software for managing components of the remote computing device 104. Similarly, the reports logic 144 a may be configured to receive data from the buyer and prime and generate one or more tier-2 supplier spending reports. The interface logic 144 b may cause the remote computing device 104 to provide the user interfaces, as well as receive and respond to inputs from the user.

It should be understood that the components illustrated in FIG. 2 are merely exemplary and are not intended to limit the scope of this disclosure. While the components in FIG. 2 are illustrated as residing within the remote computing device 104, this is merely an example. In some embodiments, one or more of the components may reside external to the remote computing device 104.

FIG. 3 depicts a user interface 330 for a buyer to create a report and manage primes, according to one or more embodiments shown and described herein. As illustrated, the user interface 330 of FIG. 3 includes a create new report option 332 and an invite/manage primes option 334. In response to selection of the create new report option 332, options for creating tier-2 reporting may be provided. As an example, the user may access information of previously subscribed primes to generate a new report. The information may include updated information from the most previous report and/or may utilize different information from previous reports. In response to selection of the invite/manage primes option 334, one or more additional options may be provided for inviting new primes to participate in reporting and/or for managing currently subscribed primes.

The user interface 330 also includes a reporting area 336, which provides information regarding previously created reports. As illustrated, the “2012 report” is related to the reporting year of 2012 and is currently open. Additional options 338 a, 338 b, 338 c, and 338 d are also provided for viewing the report, editing the report, deleting the report, and/or closing the report, as described in more detail below.

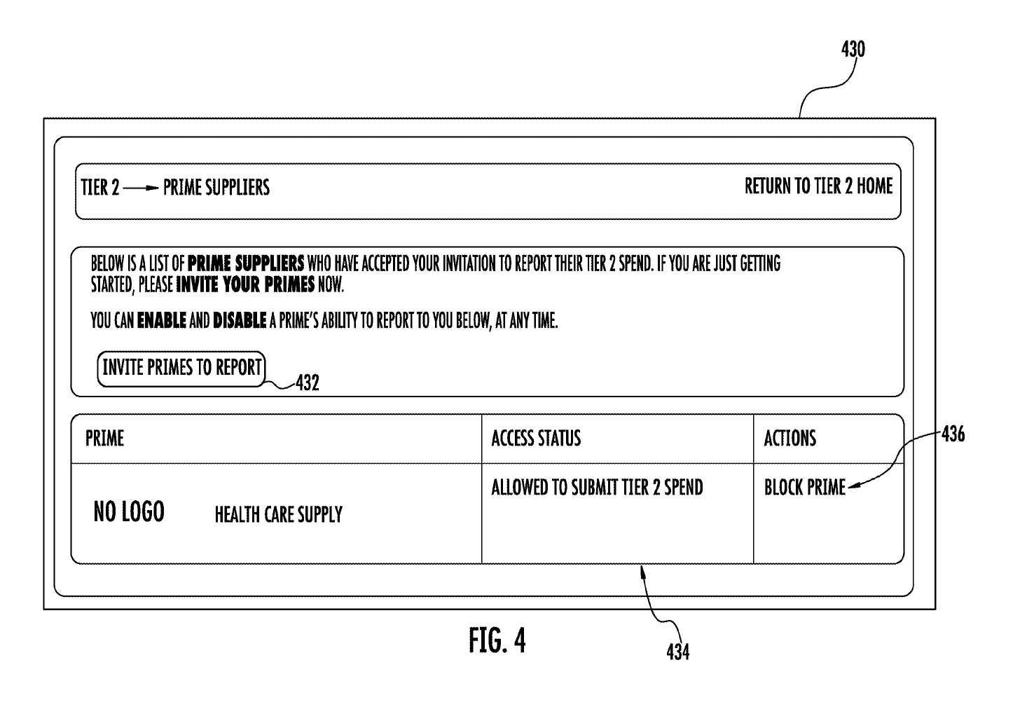

FIG. 4 depicts a user interface 430 for viewing a list of one or more primes who have accepted an invitation to report tier-2 spending, according to one or more embodiments shown and described herein. As illustrated, the user interface 430 includes an invite primes option 432, as well as a prime status section 434. In response to selection of the invite primes option 432, the user may be provided with one or more additional options for identifying the primes that the user wishes to invite. As an example, if the user wishes to purchase from a vendor, but wants to first determine the diversity that that vendor currently employs, the user can select the invite primes option 432 and then identify that vendor. The vendor may then be provided with options for sending the requested diversity data to the remote computing device 104. The remote computing device 104 may then perform analysis and/or create reports, based on that data and user commands.

Similarly, the prime status section 434 includes a listing of those primes that have accepted invitations to report tier-2 spend. Accordingly, the prime status section 434 may include a prime name and a prime access status. Also included is a block prime option 436 for blocking a prime from reporting tier-2 spend (and/or other information). As an example, if the user determines that a particular prime will not be a vendor of the user, the user may wish to not view information from that prime. As such, the user may select the block prime option 436 to refrain from receiving such information.

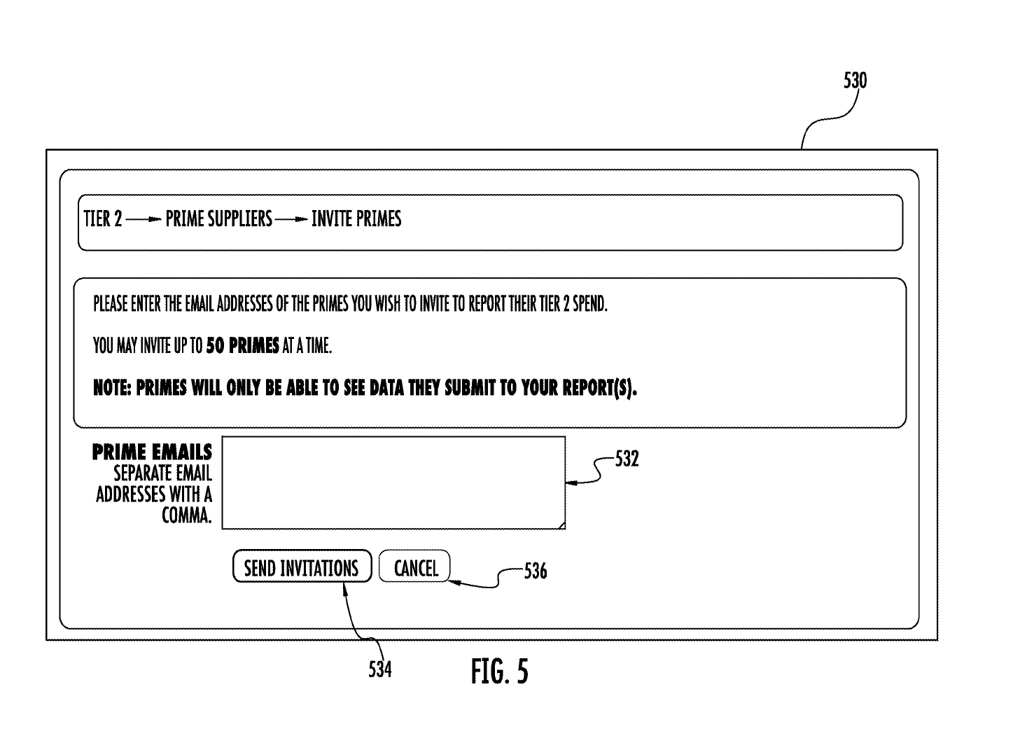

FIG. 5 depicts a user interface 530 for inviting additional primes to report tier-2 spending, according to one or more embodiments shown and described herein. In response to selection of the invite primes option 432 from FIG. 4, the user interface 530 may be provided, which includes a text prompt 532, as well as a send invitations option 534 and a cancel option 536. Specifically, the user may identify email addresses (and/or other identifiers) of primes that the user would like to report diversity and/or other tier-2 type data. Upon populating the text prompt 532, the user may select the send invitations option 534 for sending invitations to the identified primes. In response to selection of the cancel option 536, the user may be returned to the user interface 430 from FIG. 4.

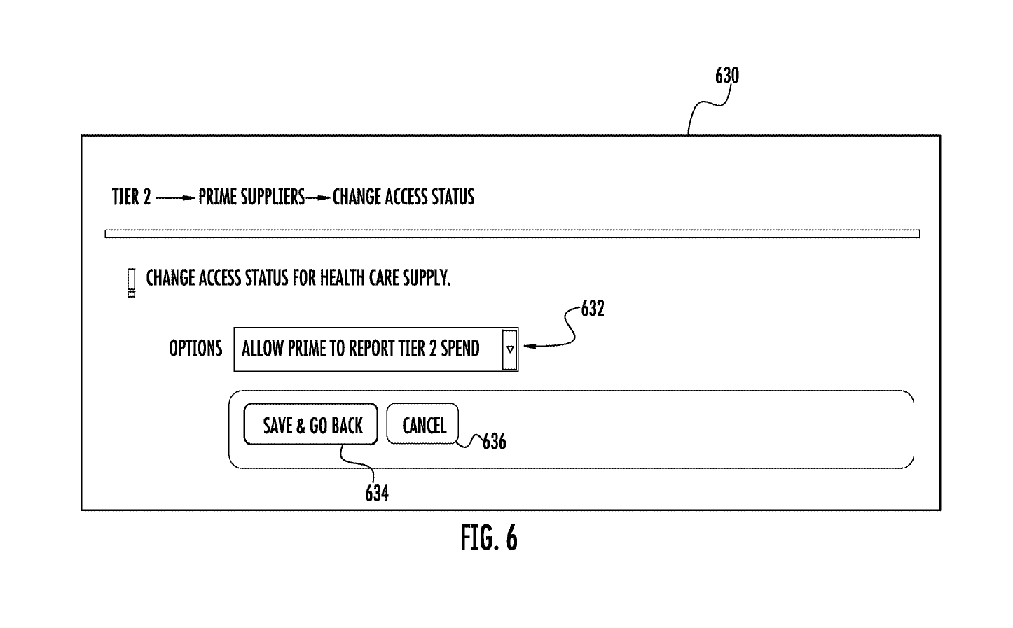

FIG. 6 depicts a user interface 630 for granting access to a prime, according to one or more embodiments shown and described herein. As illustrated, the user interface 630 may be provided in response to selection of the block prime option 436 from FIG. 4 and includes status change option 632, as well as a save option 634 and a cancel option 636. Specifically, the status change option 632 may provide sub-options such as blocking the prime, allowing the prime to report tier-2 spend, allowing the prime to only report a subset of tier-2 spend, etc. Upon selecting the desired sub-option from the status change option 632, the user may select the save option 634 for saving the selection or the cancel option 636 for not changing the status of the prime.

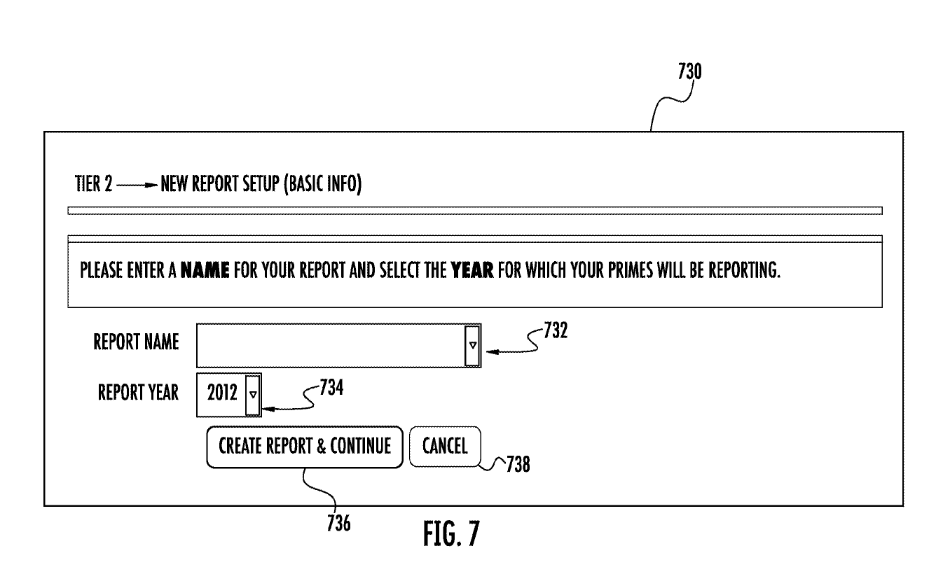

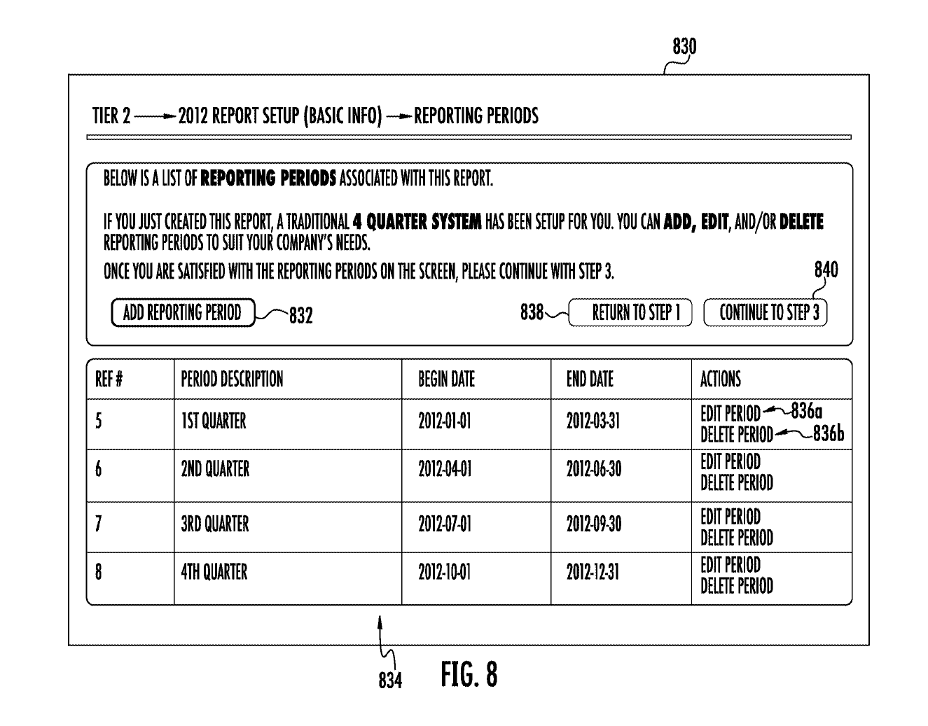

FIG. 7 depicts a user interface 730 for setting up a new report of tier-2 spending, according to one or more embodiments shown and described herein. In response to selection of the create new report option 332 from FIG. 3, the user interface 730 may be provided. The user interface 730 includes a report name field 732, a report year field 734, a create report option 736 and a cancel option 738. Accordingly, if the user wishes to create a new report, the user may input the desired report name into the report name field 732. The user may select a reporting year in the report year field 734. The user may then select the create report option 736 for creating the report and proceeding to the user interface 830 of FIG. 8. In response to selection of the cancel option 738 the report will not be created.

FIG. 8 depicts a user interface 830 for viewing and editing reporting periods for tier-2 spending, according to one or more embodiments shown and described herein. In response to selection of the create report option 736 from FIG. 7, the user interface 830 may be provided. As illustrated, the user interface 830 includes an add reporting period option 832 for adding a reporting period for this newly created report, as well as a period listing area 834, a return option 836, and a proceed option 840. As an example, the user may wish for annual reporting, semi-annual reporting, quarterly reporting, monthly reporting, weekly reporting, and/or other temporal and/or benchmark reporting periods. Examples of benchmark periods may include reporting when diversity spending reaches a particular threshold and/or other diversity thresholds that are reached.

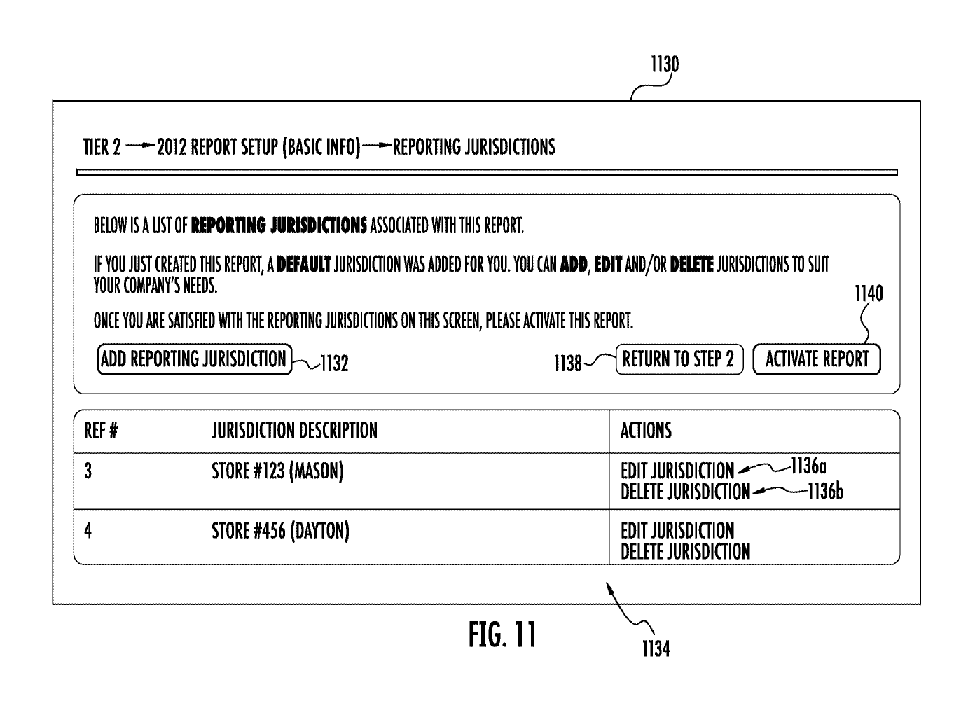

Accordingly, the period listing area 834 provides previously added periods for the new report, as well as a period description, a begin date, an end date and one or more actions that may be performed for the reporting period. As an example, the actions may include an edit period option 836 a for editing one or more pieces of information related to the reporting period and a delete period option 836 b for deleting the period. In response to selection of the return option 838, the remote computing device 104 may return the user to a previous user interface. In response to selection of the proceed option 840, the user interface 1130 of FIG. 11 may be provided.

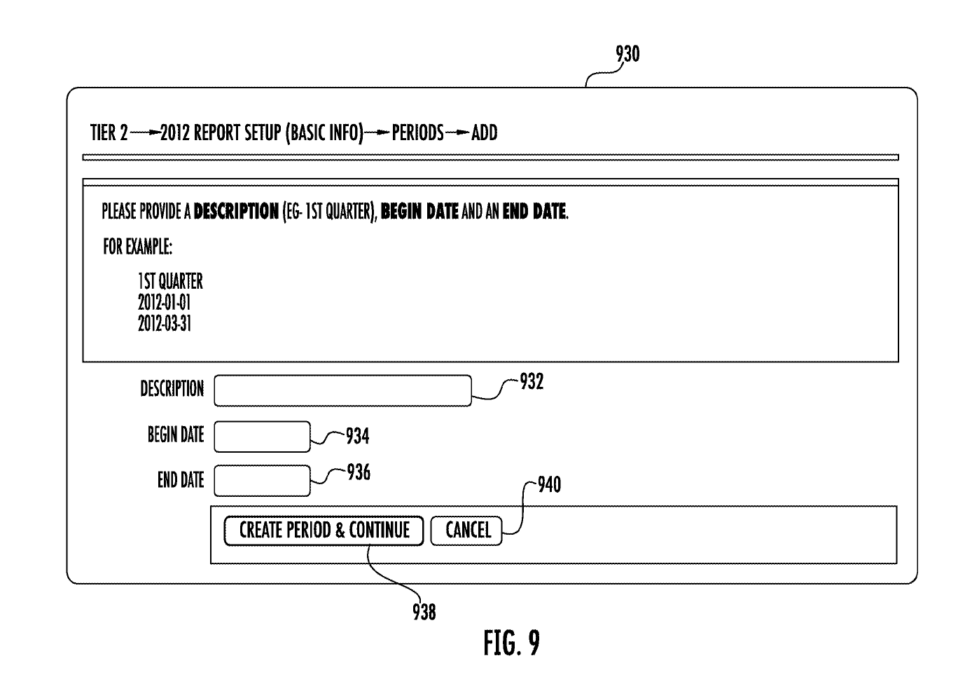

FIG. 9 depicts a user interface 930 for adding an additional reporting period for tier-2 spending, according to one or more embodiments shown and described herein. In response to selection of the add reporting period option 832 from FIG. 8, the user interface 930 may be provided. As illustrated, the user interface 930 includes a description field 932, a begin date field 934, an end date field 936, a create period option 938, and a cancel option 940. The user may populate the description field 932 with a user-defined description. Similarly, the user may provide a begin date in the begin date field 934 and an end data in the end date field 936. Once the user has input the desired information, the user may select the create period option 938. If the user wishes to not create this period, the user may select the cancel option 940.

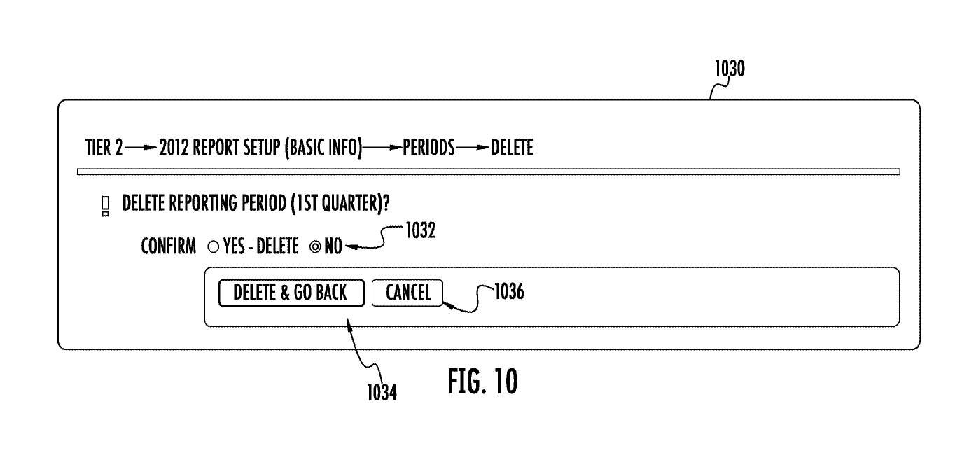

FIG. 10 depicts a user interface 1030 for deleting a reporting period for tier-2 spending, according to one or more embodiments shown and described herein. In response to selection of the delete period option 836 b from FIG. 8, the user interface 1030 may be provided. As illustrated, the user interface 1030 includes a confirm field option 1032, a delete option 1034, and a cancel option 1036. Specifically, if the user wishes to delete a reporting period, the user selects the appropriate delete period option 836 b from FIG. 8 and confirms that deletion via the confirm field option 1032. The user may then select the delete option 1034 of permanent deletion.

FIG. 11 depicts a user interface 1130 for setting up reporting jurisdictions of tier-2 reporting, according to one or more embodiments shown and described herein. In response to selection of the proceed option 840 from FIG. 8, the user interface 1130 may be provided. As illustrated, the user interface 1130 includes an add reporting jurisdiction option 1132, a reporting jurisdictions area 1134, a return option 1138, and an activate report option 1140. The add reporting jurisdiction option 1132 may be configured for the user to add a reporting jurisdiction. As an example, if the user wishes the report to only contain information regarding a particular branch, store, geographic area, and/or other subset of a prime, the user may so select these criteria. In this vein, the reporting jurisdictions area 1134 may provide default jurisdictions as selected by the remote computing device 104 and/or jurisdictions that the user has created. Also included in the reporting jurisdictions area 1134 are an edit jurisdiction option 1136 a and a delete jurisdiction option 1136 b for editing and deleting a jurisdiction, respectively. In response to selection of the return option 1138, the remote computing device 104 may return the user to the user interface 1030 from FIG. 10. In response to selection of the activate report option 1140, the new report may be activated.

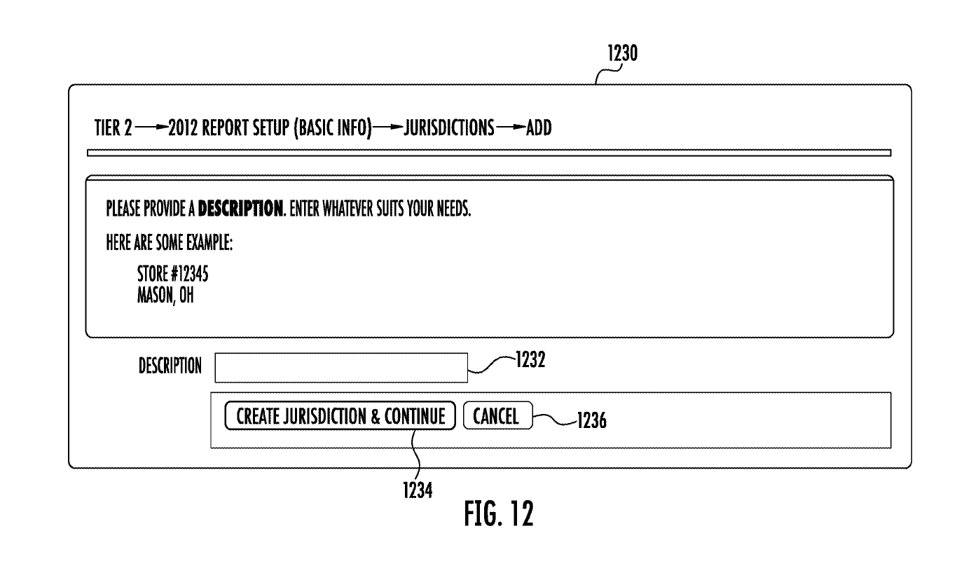

FIG. 12 depicts a user interface 1230 for adding an additional reporting jurisdiction for tier-2 spending, according to one or more embodiments shown and described herein. In response to selection of the add reporting jurisdiction option 1132 from FIG. 11, the user interface 1230 may be provided. As illustrated, the user interface 1230 includes a description field 1232, a create jurisdiction option 1234, and a cancel option 1236. The user may populate the description field 1232 with an appropriate description of the jurisdiction and may then select the create jurisdiction option 1234 for creating the jurisdiction. The user may select the cancel option 1236 for canceling this action.

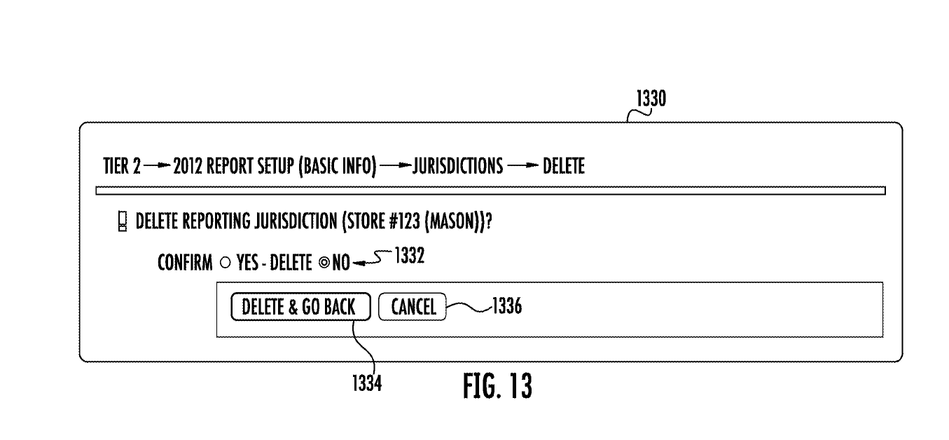

FIG. 13 depicts a user interface 1330 for deleting a reporting jurisdiction for tier-2 spending, according to one or more embodiments shown and described herein. In response to selection of the delete jurisdiction option 1138 b from FIG. 11, the user interface 1330 may be provided. As illustrated, the user interface 1330 includes a confirm field 1332, a delete option 1334, and a cancel option 1336. If the user wishes to delete a jurisdiction and selects the delete jurisdiction option 1138 b from FIG. 11, the user may then confirm the deletion by selecting the appropriate radio option on the confirm field 1332 and selecting the delete option 1334. If the user wishes to cancel this action, the user may select the cancel option 1336.

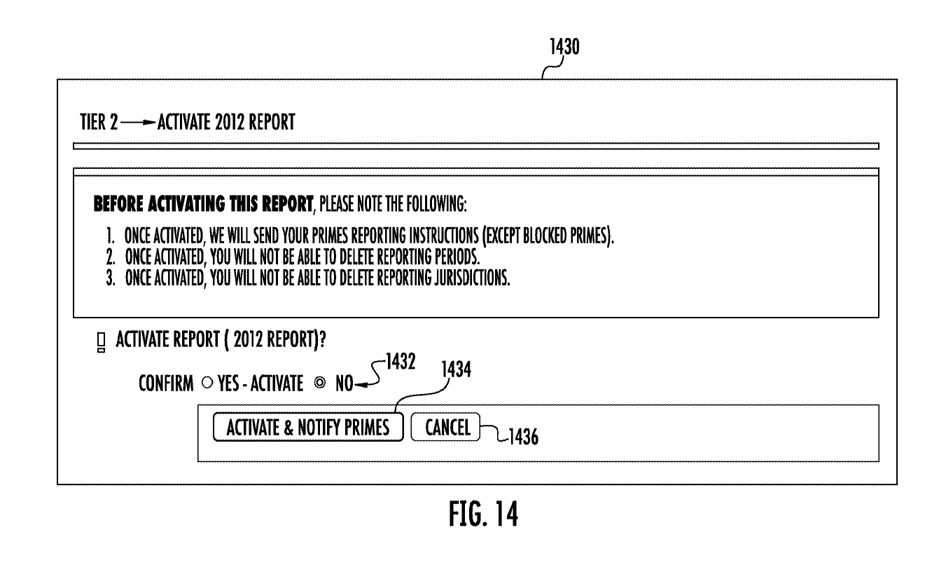

FIG. 14 depicts a user interface 1430 for activating a report for prime suppliers of tier-2 spending, according to one or more embodiments shown and described herein. In response to creating the report, as well as creating the reporting period and/or jurisdiction, the user may activate the report via the user interface 1430, thereby creating a report request for a prime to create a report. As illustrated, the user interface 1430 includes a confirm field 1432, an activate option 1434, and a cancel option 1436. In response to selection of the appropriate radio option in the confirm field 1432 and selection of the activate option 1434, the report may be created for automatic generation (according to the reporting period). If the user does not wish to create the report, the user may select the cancel option 1436.

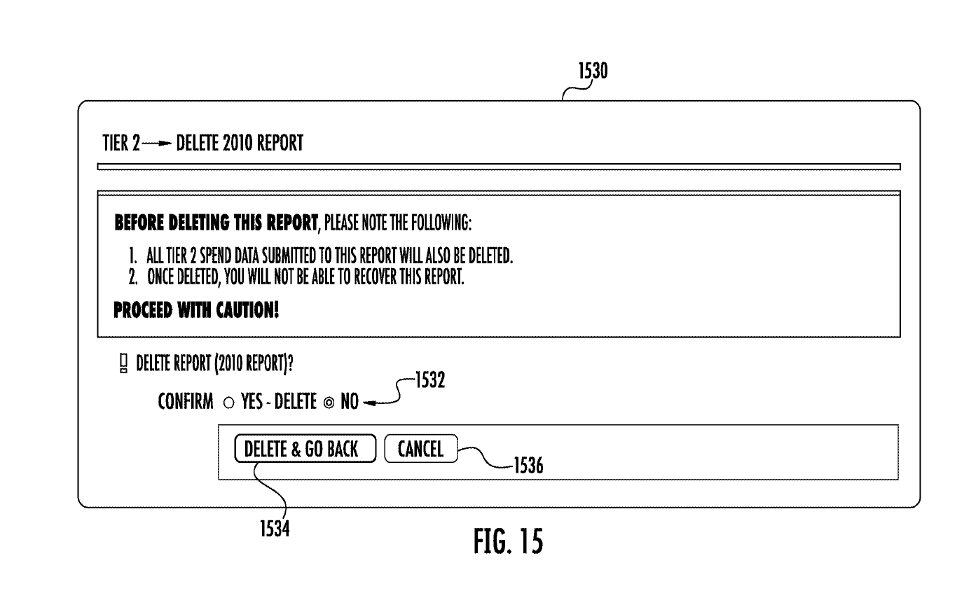

FIG. 15 depicts a user interface 1530 for deleting a report, according to one or more embodiments shown and described herein. In response to selection of the delete report option 338 d from FIG. 3, the user interface 1530 may be provided. As illustrated, the user interface 1530 includes a confirm field 1532, a delete option 1534, and a cancel option 1536. If the user wishes to delete a report and selects the delete report option 338 d from FIG. 3, the user may then select the appropriate option in the confirm field 1532 and then select the delete option 1534. If the user wishes to cancel this operation, the user may select the cancel option 1536.

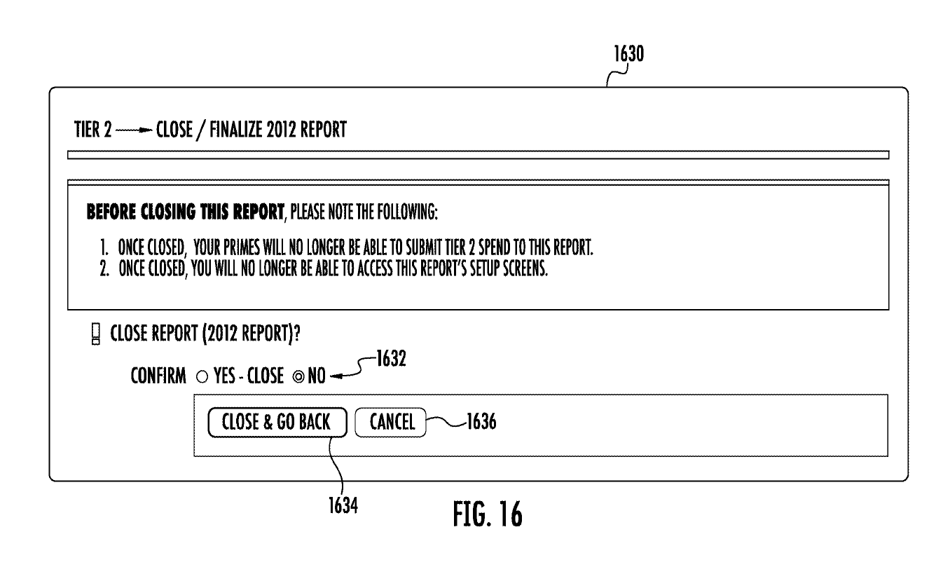

FIG. 16 depicts a user interface 1630 for finalizing a report, according to one or more embodiments shown and described herein. In response to selection of the close report option 338 c from FIG. 3, the user interface 1630 may be provided. As illustrated, the user interface 1630 includes a confirm field 1632, a close option 1634, and a cancel option 1636. If the user wishes to close a report and selects the corresponding close report option 338 c from FIG. 3, the user may then select the appropriate radio option from the confirm field 1632 and the close option 1634.

It should be understood that closing a report may be different than deleting a report in one or more ways. Specifically, if a user wishes to delete all data submitted to the report, the user should select delete report option 338 d from FIG. 3 and should proceed as described with reference to FIG. 15. If the user only wishes to close the report such that a prime may no longer submit data, but maintain the data that is has already been received, the user may select the close report option 338 c and may proceed as described as described with reference to FIG. 16.

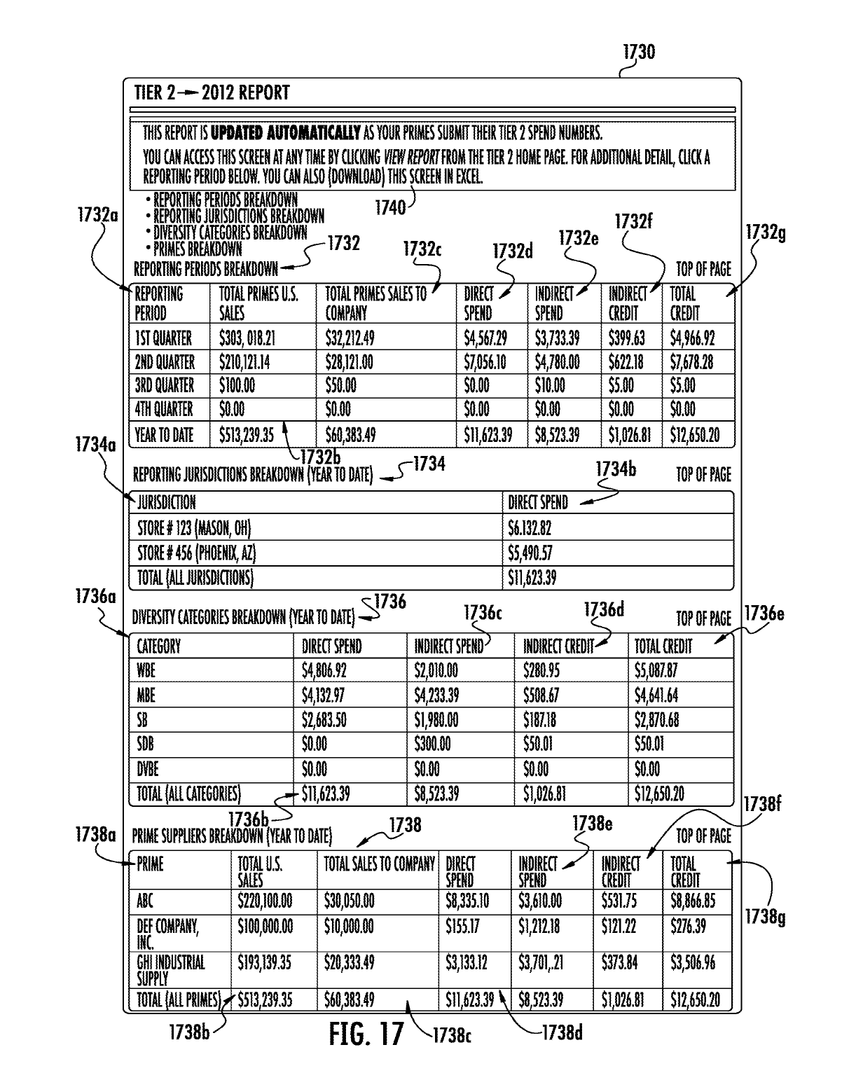

FIG. 17 depicts a user interface 1730 for providing a tier-2 report, according to one or more embodiments shown and described herein. In response to selection of the view report option 338 a from FIG. 3, the user interface 1730 may be provided. As illustrated, the user interface 1730 includes a reporting period breakdown area 1732, a reporting jurisdiction breakdown area 1734, a diversity categories breakdown area 1736, and a prime supplier breakdown area 1738. The reporting period breakdown area 1732 provides information related to the designated (and/or default) reporting periods and includes a reporting period field 1732 a, a total prime sales field 1732 b, a total prime sales to a particular customer field 1732 c, a direct spend field 1732 d, an indirect spend field 1732 e, an indirect credit field 1732 f, and a total credit field 1732 g. As will be understood, the total prime sales field 1732 b provides tier-2 sales statistics of all primes in the United States, while the total prime sales to a particular customer field 1732 c provides information regarding sales figures for a particular customer (in this example, the user's company). The direct spend field 1732 d relates to all direct sales for tier-2 customers, while the indirect spend field 1732 e relates to sales data indirectly related to tier-2 customers. Similarly, the indirect credit field 1732 f identifies the amount credited indirectly for tier-2 customers. As an example, if a company spends $100 for the inputs to produce a unit, and 20 percent of all input costs were spent with diverse suppliers, then $20 of that unit cost counts as direct diverse spend for the company and as indirect spend for the customers of that company. The total credit field 1732 g provides data related to the total credits provided during each of the reporting periods.

Similarly, the reporting jurisdiction breakdown area 1734 includes a jurisdiction field 1734 a and a direct spend field 1734 b. The jurisdiction field 1734 a may provide the default and/or user selected jurisdictions, as described above. The direct spend field 1734 b provides the tier-2 spending for each of the depicted jurisdictions.

The diversity categories breakdown area 1736 includes a category field 1736 a, a direct spend field 1736 b, and indirect spend field 1736 c, and indirect credit field 1736 d, and a total credit field 1736 e. As an example, diversity categories include women's business enterprise (WBE), minority business enterprise (MBE), small business (SB), small disadvantaged business (SDB), disabled veteran business enterprise (DVBE), etc. As illustrated, the direct spend field 1736 b identifies direct spending for each of these diversity categories. The indirect spend field 1736 c, the indirect credit field 1736 d, and the total credit field 1736 e each provide the corresponding information for each of the categories of diverse businesses.

Provided in the prime supplier breakdown area 1738 is information for each of the primes individually. Accordingly, the total sales field 1738 b provides total U.S. sales for each of the primes. The total sales to a particular company field 1738 c provides total sales numbers for purchases to the particular company (in this example, the user's company). The direct spend field 1738 d provides the direct spend for each of the primes. The indirect spend field 1738 e provides the amount that was indirectly spent. Similarly, the indirect credit field 1738 f provides indirect credits for each of the primes. The total credit field 1738 g provides the total credit for each of the primes.

It should be noted that in some embodiments, the user interface 1730 and related data are stored remotely on the remote computing device 104. Accordingly, in these embodiments, a download option 1740 may be provided for the user to download and store at least a portion of the information locally.

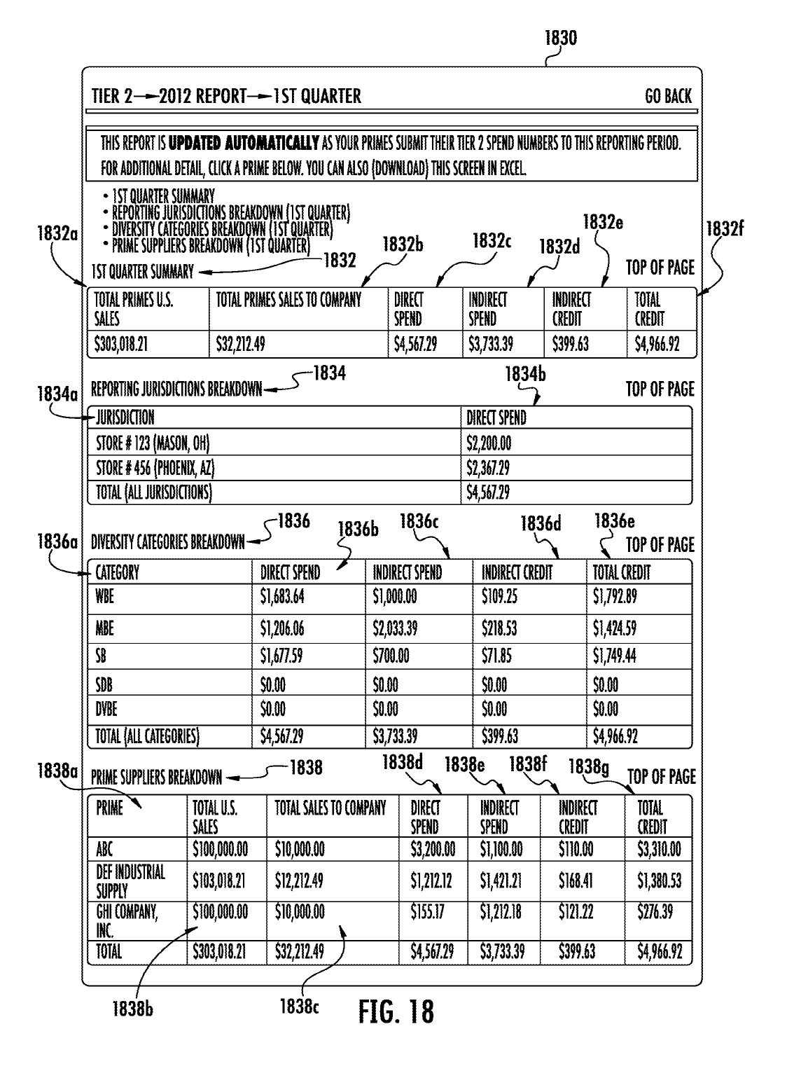

FIG. 18 depicts a user interface 1830 for a first quarter tier-2 report, according to one or more embodiments shown and described herein. In response to selecting one of the periods from the reporting period field 1732 a from FIG. 17, the user interface 1830 may be provided. As illustrated, the user interface 1830 includes a 1^{st} quarter summary area 1832, a reporting jurisdiction breakdown area 1834, a diversity categories area 1836, and a prime supplier breakdown area 1838. The 1^{st} quarter summary area 1832 includes a total prime sales field 1832 a, which provides financial information related to all prime sales for the selected period. The total prime sales to a particular company field 1832 b provides financial information between all primes and a predetermined company (in this embodiment, the user's company). The direct spend field 1832 c identifies an amount that was directly spent by primes for the selected period. The indirect spend field 1832 d provides an amount that was indirectly spent for the period. The indirect credit field 1832 e provides information related to indirect credit information. The total credit field 1832 f provides an amount of total credit for the primes during the period.

Similarly, the reporting jurisdiction breakdown area 1834 provides a jurisdiction field 1834 a, which includes default and/or user-defined jurisdictions. The direct spend field 1834 b provides an amount spent for each of the jurisdictions provided during the selected period.

The diversity categories area 1836 provides a diversity category field 1836 a for providing one or more diversity categories, as described above. The direct spend field 1836 b provides financial information related to the direct spending for each of the categories of diversity businesses during the selected period. The indirect spend field 1836 c provides indirect spending for each of the types of businesses provided during the selected period. The indirect credit field 1836 d provides a total credit of the business category for the selected period.

The prime supplier breakdown area 1838 includes a prime field 1838 a for listing a plurality of primes. The total sales field 1838 b provides the sales of each of the primes for the selected period. The total sales to a particular company field 1838 c provides financial data related to sales to a predetermined company (in this embodiment, the user's company). The direct spend field 1838 d provides direct spending financial data for each of the primes during the selected period. The indirect spend field 1838 e provides indirect spending data. The indirect credit field 1838 f provides indirect credit data. The total credit field 1838 g provides a total credit for each of the primes during the selected period.

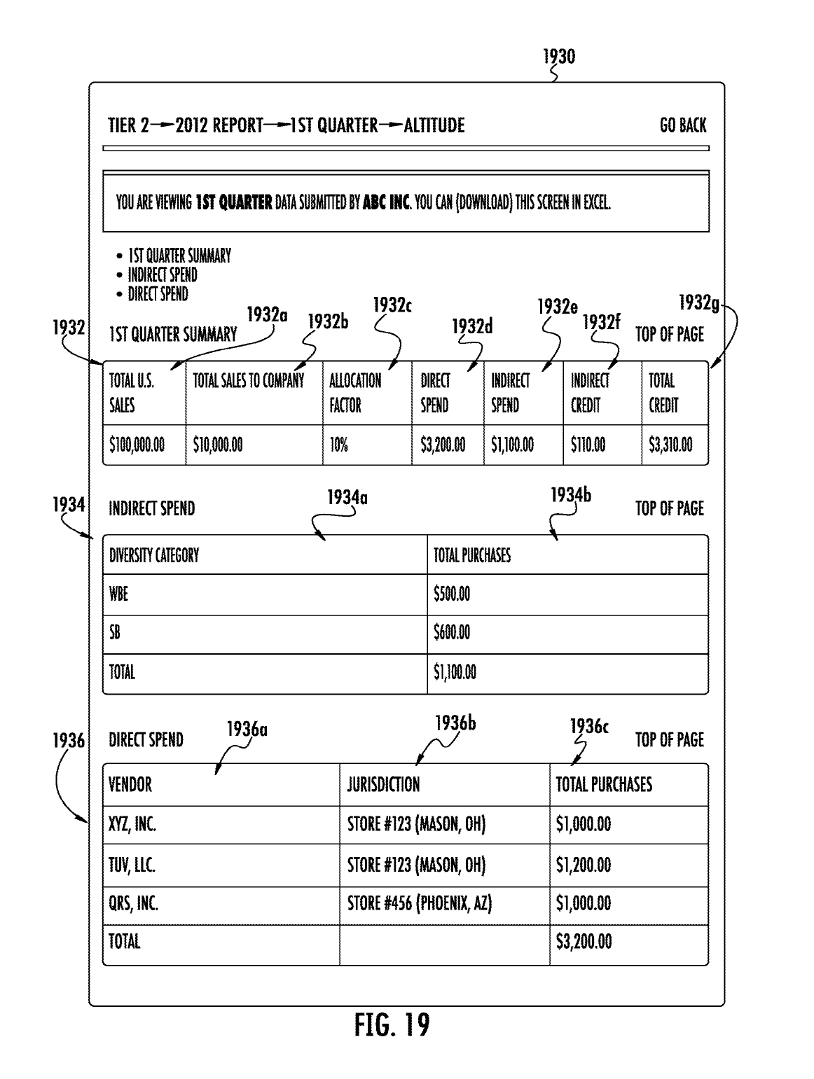

FIG. 19 depicts user interface 1930 for providing a first quarter summary report of direct spending and indirect spending, according to one or more embodiments shown and described herein. In response to selection of one of the primes from the prime field 1838 a of FIG. 18, the user interface 1930 may be provided. As illustrated, the user interface 1930 includes a 1^{st} quarter summary section 1932, an indirect spend area 1934, and a direct spend area 1936 for a selected prime. In the 1^{st} quarter summary section 1932, a total sales field 1932 a is provided for the particular prime and during the selected period. In the total sales to a particular company field 1932 b, the sales data for a prime during the selected period to the predetermined company is provided. The allocation factor field 1932 c indicates a percentage of sales this prime had versus all other primes for this company and during this period. The direct spend field 1932 d provides direct spend data. The indirect spend field 1932 e provides indirect spend data during the selected period. As discussed above, the indirect credit field 1932 f and the total credit field 1932 g provide the indirect and total credit data respectively, for this particular prime and during the selected period.

In the indirect spend area 1934, a diversity category field 1934 a is provided to show which categories of suppliers were used by this prime in the indirect sales. The total purchases field 1934 b provides the financial data associated with these diversity categories.

In the direct spend area 1936, a vendor field 1936 a is provided that identifies various vendors for the prime during the selected period. The jurisdiction field 1936 b identifies the jurisdiction associated with those vendors. The total purchases field 1936 c identifies a value of the purchases that were made by with the vendors during the selected period.

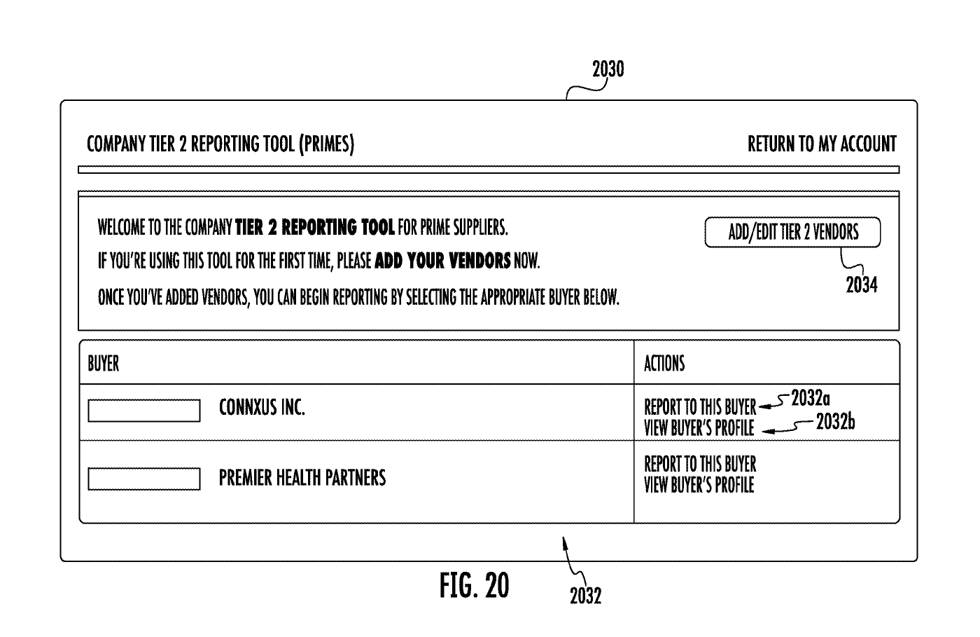

FIG. 20 depicts a user interface 2030 for a prime to add tier-2 suppliers to the prime account, according to one or more embodiments shown and described herein. In response to a user selection of the send invitations option 534 from FIG. 5, a potential prime may be sent an indication to create an account and thereby provide a data request for reporting tier-2 diversity data. Accordingly, the prime may create the account and may identify vendors that the prime uses via the user interface 2030. As illustrated, the user interface 2030 of FIG. 20 includes a buyer listing area 2032 and an add/edit tier-2 vendors option 2034. The buyer listing area 2032 may include a listing of all buyers that are associated with this prime. Included within the buyer listing area 2032 are a report option 2032 a and a view profile option 2032 b. In response to selection of the report option 2032 a, the prime may report their tier-2 spending to that particular buyer. In response to selection of the view profile option 2032 b, profile for the selected buyer may be provided.

Also included in the user interface 2030 is the add/edit tier-2 vendors option 2034. In response to selection of the add/edit tier-2 vendors option, additional options for adding and/or editing vendors for this prime may be provided, as described in more detail below.

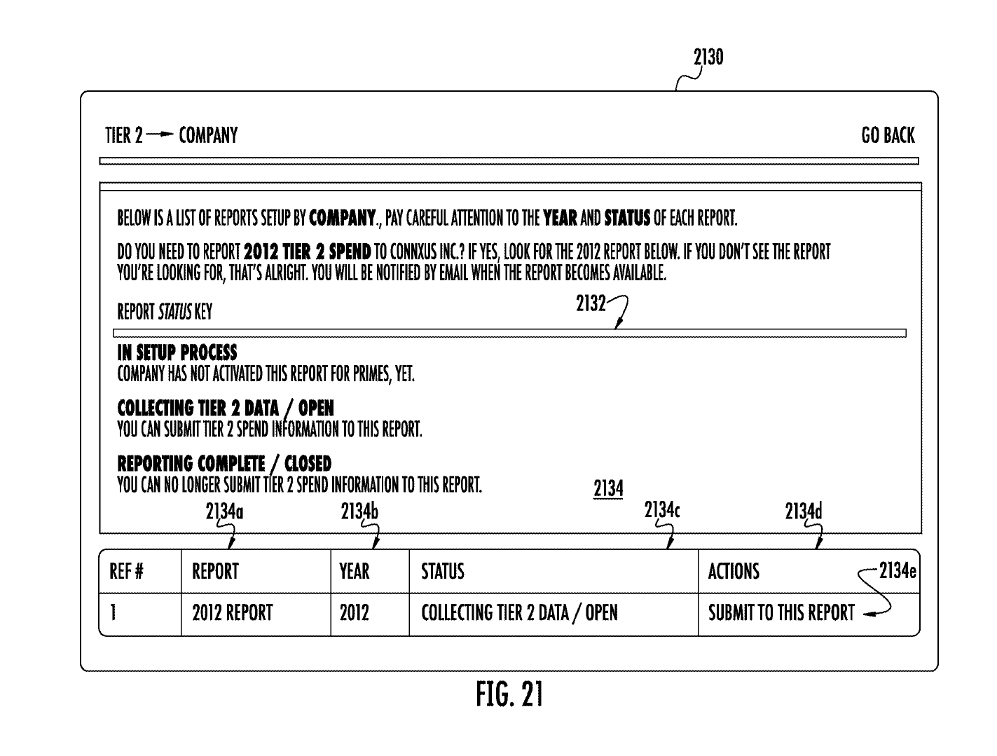

FIG. 21 depicts a user interface 2130 for providing a prime with a list of reports setup by a buyer of the prime, according to one or more embodiments shown and described herein. In response to selection of the view profile option 2032 b, the user interface 2130 may be provided. As illustrated, the user interface 2130 includes a report status key 2132, as well as a status chart area 2134. The report status key 2132 provides a description related to information in the status chart area 2134. The status chart area 2134 includes a reference number field, a report name field 2134 a, a year field 2134 b, a status field 2134 c, and an actions field 2134 d, and a submit option 2134 e. The report name field 2134 a provides a designated name for each of the reports. The year field 2134 b provides the year (or other period) that the report addresses. The status field 2134 c provides the current status report, as outlined in the report status key 2132. The actions field 2134 d provides the available actions for the prime to select for a report. In response to selection of the submit option 2134 e, the report may be submitted to the remote computing device 104 for providing to one or more predetermined companies.

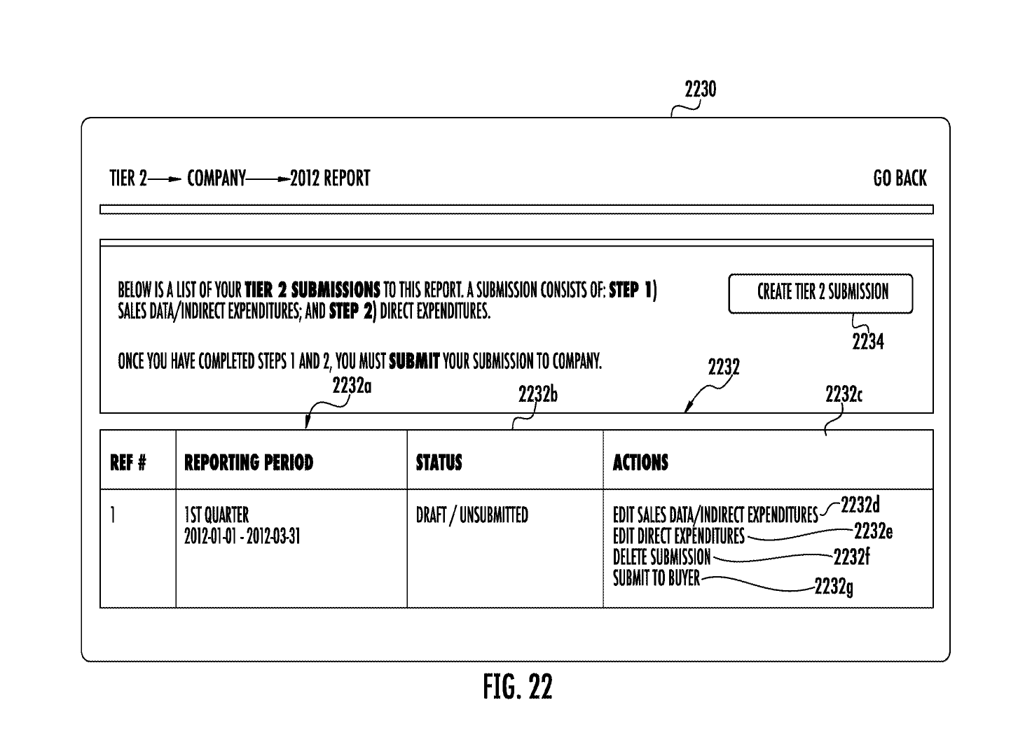

FIG. 22 depicts a user interface 2230 for providing a tier-2 submission for a report, according to one or more embodiments shown and described herein. In response to selecting a report from the report name field 2134 a in FIG. 21, the user interface 2230 may be provided. As illustrated, the user interface 2230 includes report area 2232 and a create submission option 2234. Specifically, the report area 2232 includes a reporting period field 2232 a, a status field 2232 b, and an actions field 2232 c. The reporting period field 2232 a provides submissions for user-defined (and/or default) periods. The status field 2232 b provides the current status of the submission. The actions field 2232 c provides options for the submission. As an example, the actions field 2232 c includes an edit indirect option 2232 d, an edit direct option 2232 e, a delete option 2232 f, and a submit option 2232 g. In response to selection of the edit indirect option 2232 d, options for editing the indirect expenditures and/or sales data may be provided. In response to selection of the edit direct option 2232 e, options for editing the direct expenditures may be provided. In response to selection of the delete option 2232 f, the corresponding submission may be deleted. In response to selection of the submit option 2232 g, the submission may be submitted to the buyer. Similarly, in response to selection of the create submission option 2234 a new submission for the report may be created.

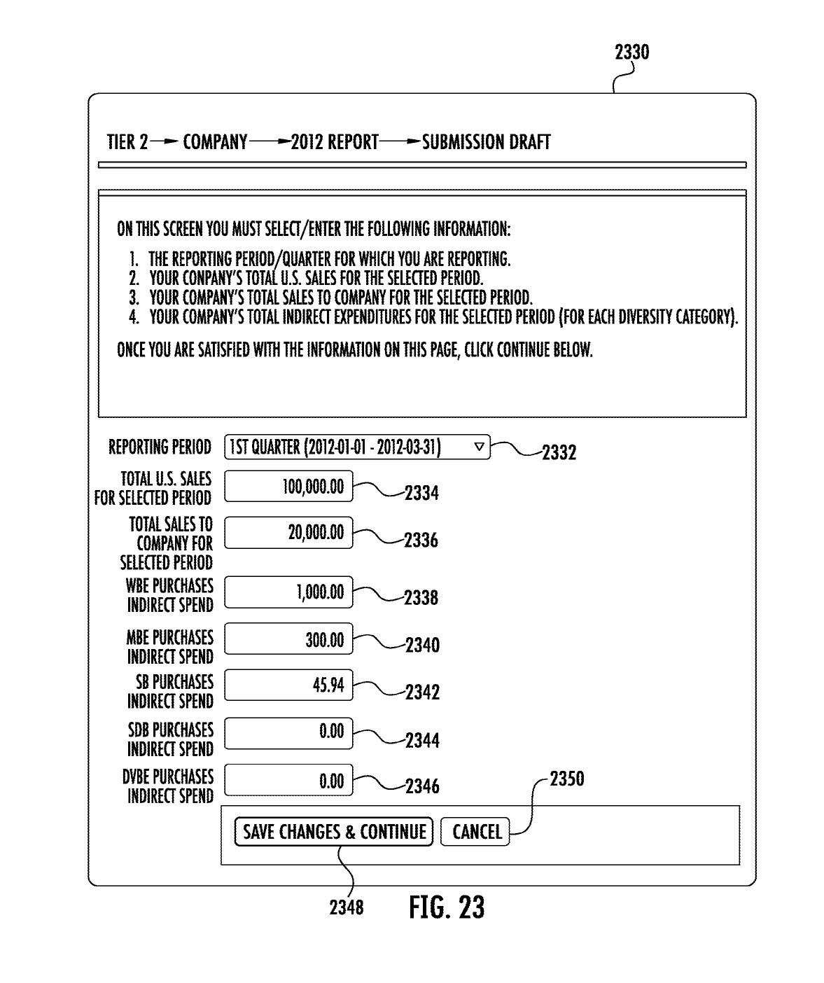

FIG. 23 depicts a user interface 2330 for a prime to submit a draft report of tier-2 diversity spending, according to one or more embodiments shown and described herein. In response to selection of the create submission option 2234, the user interface 2330 may be provided. As illustrated, the user interface 2330 includes a reporting period field 2332, a total sales field 2334, a total sales to buyer field 2336, a WBE purchases field 2338, a MBE purchases field 2340, an SB purchases field 2342, an SDB purchases field 2344, a DVBE purchases field 2346, a save option 2348, and a cancel option 2350. In the reporting period field 2332, the prime may manually select the desired reporting period for this submission. In the total sales field 2334, the prime may enter the total U.S. sales for the selected period. In the total sales to buyer field 2336, the prime may enter the total sales made during the period for the particular company. In the WBE purchases field 2338, the prime may enter the indirect spend with WBEs during the selected period. In the MBE purchases field 2340, the prime may enter the indirect spend with MBEs during the selected period. In the SB purchases field 2342, the prime may enter the indirect spend with SBs during the selected period. In the SDB purchases field 2344, the prime may enter the indirect spend with SDBs during the selected period. In the DVBE purchases field 2346, the prime may enter the indirect spend with DVBEs during the selected period. Once the prime has entered the desired information, selection of the save option 2348 will save the submission draft. Selection of the cancel option 2350 cancels the actions performed in the user interface 2330.

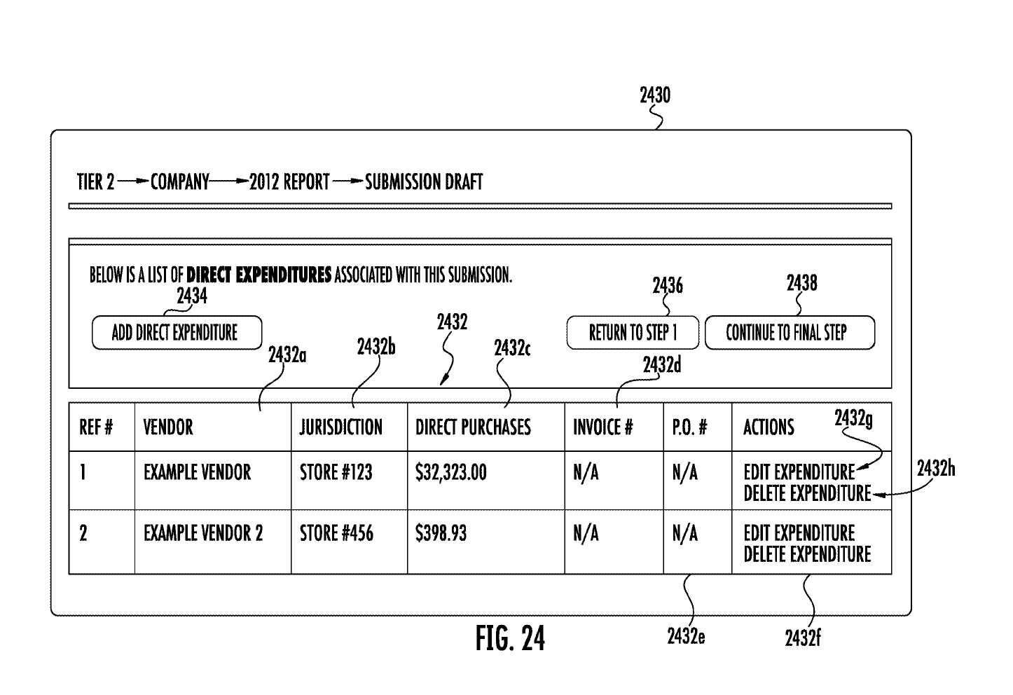

FIG. 24 depicts a user interface 2430 for viewing and editing direct expenditures by a prime, according to one or more embodiments shown and described herein. In response to selection of the edit direct option 2232 e, the user interface 2430 may be provided. As illustrated, the user interface 2430 includes a direct expenditure area 2432, an add option 2434, a return option 2436, and a continue option 2438. The direct expenditure area 2432 includes a vendor field 2432 a, a jurisdiction field 2432 b, a direct purchases field 2432 c, an invoice field 2432 d, a purchase order field 2432 e, and an actions field 2432 f. The vendor field 2432 a includes one or more vendors with which the prime had a direct expenditure. The jurisdiction field 2432 b includes a jurisdiction for the provided vendors. The direct purchases field 2432 c provides a value of the direct purchases made with the vendors. The invoice field 2432 d and the purchase order field 2432 e provide an invoice number and a purchase number, respectively. The actions field 2432 f provides options that may be performed for the expenditure. As an example, the actions field 2432 f may include an edit expenditure option 2432 g and a delete option 2432 h.

Also included in the user interface 2430 are the add option 2434, the return option 2436 and the continue option 2438. In response to selection of the add option 2434, an expenditure may be added to the report. In response to selection of the return option 2436, the prime may be returned to a previous user interface. In response to selection of the continue option 2438, the prime may proceed to another user interface.

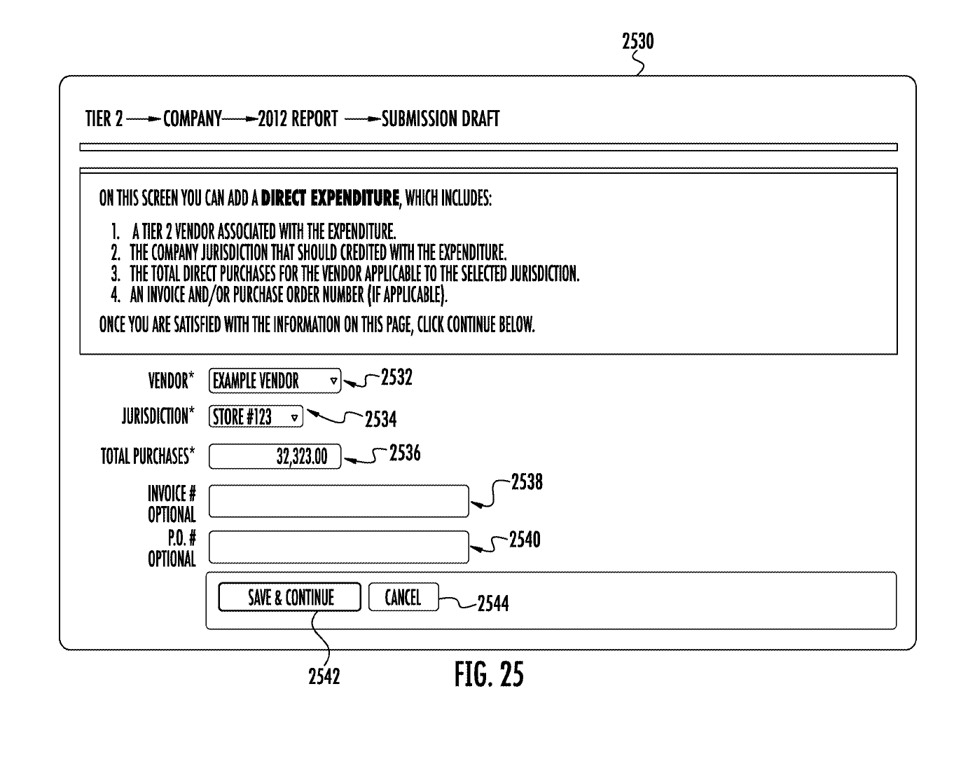

FIG. 25 depicts a user interface 2530 for a prime to add a direct expenditure, according to one or more embodiments shown and described herein. In response to selection of the add option 2434 from FIG. 24, the user interface 2530 may be provided. As illustrated, the user interface 2530 includes a vendor field 2532, a jurisdiction field 2534, a total purchases field 2536, an invoice number field 2538, a purchase order number field 2540, a save option 2542, and a cancel option 2544. In the vendor field 2532, the prime may select a vendor for this expenditure. In the jurisdiction field 2534, the prime may select a jurisdiction associated with this expenditure. In the total purchases field 2536, the prime may enter the value of purchases made from this vendor. In the invoice number field 2538 and the purchase order number field 2540, the prime may enter the invoice number and the purchase number, respectively. In response to selection of the save option 2542, the information may be saved. In response to selection of the cancel option 2544, the direct expenditure submission may be canceled.

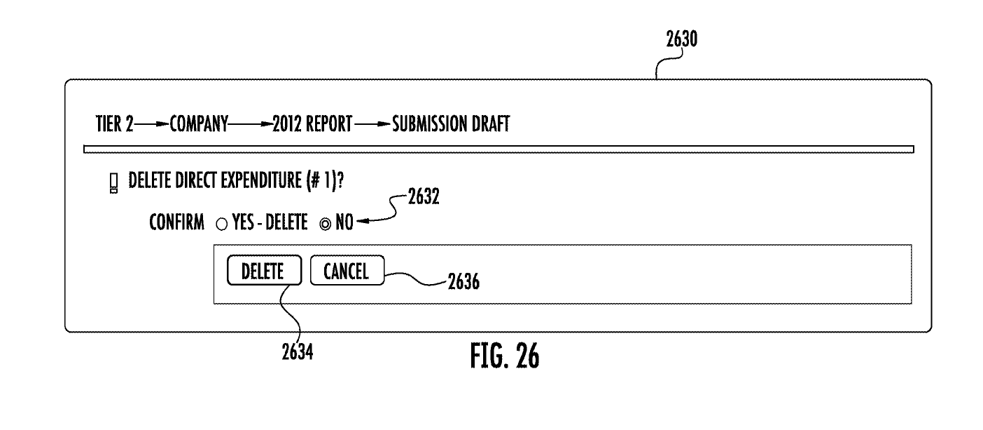

FIG. 26 depicts a user interface 2630 for a prime to delete a direct expenditure, according to one or more embodiments shown and described herein. In response to selection of the delete option 2432 h, the user interface 2630 may be provided. As illustrated, the user interface 2630 includes a confirm field 2632, a delete option 2634, and a cancel option 2636. If the prime desires to delete a submission, the user may select the appropriate radio option in the confirm field 2632 and then select the delete option 2634. If the prime wishes to cancel this deletion, he/she may select the cancel option 2636.

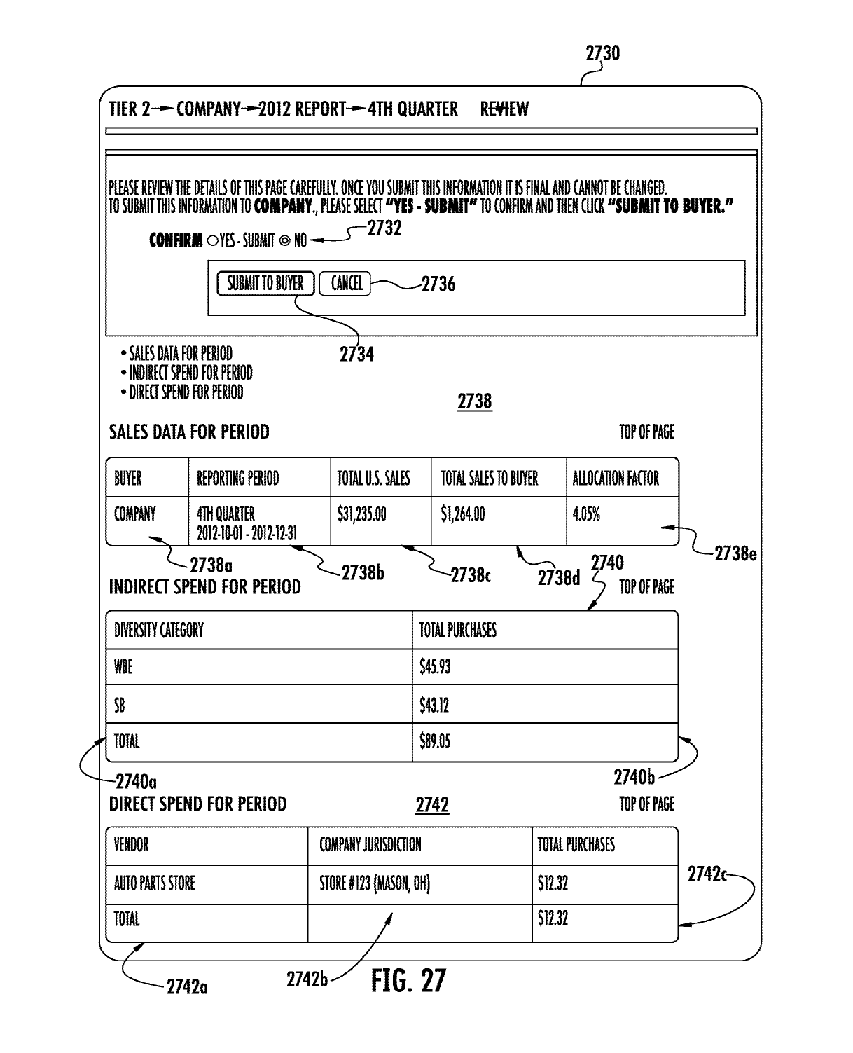

FIG. 27 depicts a user interface 2730 for a prime to view and submit a report to a buyer, according to one or more embodiments shown and described herein. In response to selection of the submit option 2232 g from FIG. 22, the user interface 2730 may be provided. As illustrated, the user interface 2730 includes a confirm field 2732, a submit option 2734, a cancel option 2736, a sales data area 2738, an indirect spend area 2740, and a direct spend area 2742. If the prime wishes to submit the report to the buyer, the prime may select the appropriate radio option in the confirm field 2732 and select the submit option 2734. If the user wishes to cancel submission, he/she may select the cancel option 2736.

Additionally, the sales data area 2738 includes a buyer field 2738 a, a reporting period field 2738 b, a total sales field 2738 c, a total sales to buyer field 2738 d, and an allocation factor field 2738 e. The indirect spend area 2740 includes a diversity category field 2740 a and a total purchases field 2740 b that indicates purchases for each category of business. The direct spend area 2742 includes a vendor field 2742 a, a jurisdiction field 2742 b, and a total purchases field 2742 c.

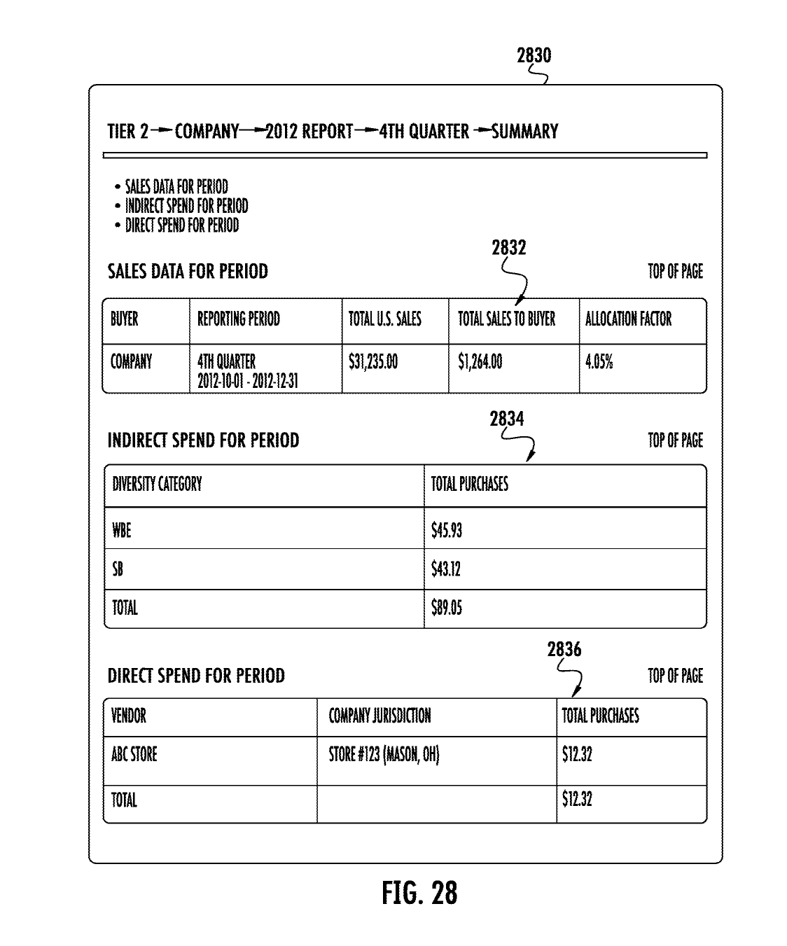

FIG. 28 depicts a user interface 2830 for a prime to view a quarterly summary report for a buyer, according to one or more embodiments shown and described herein. In response to selection of the submit option 2734 from FIG. 27, the user interface 2830 may be provided. As illustrated, the user interface 2830 includes a sales data area 2832, an indirect spend area 2834, and a direct spend area 2836. These areas correspond to the similarly labeled areas in FIG. 27 and confirm the data that was submitted.

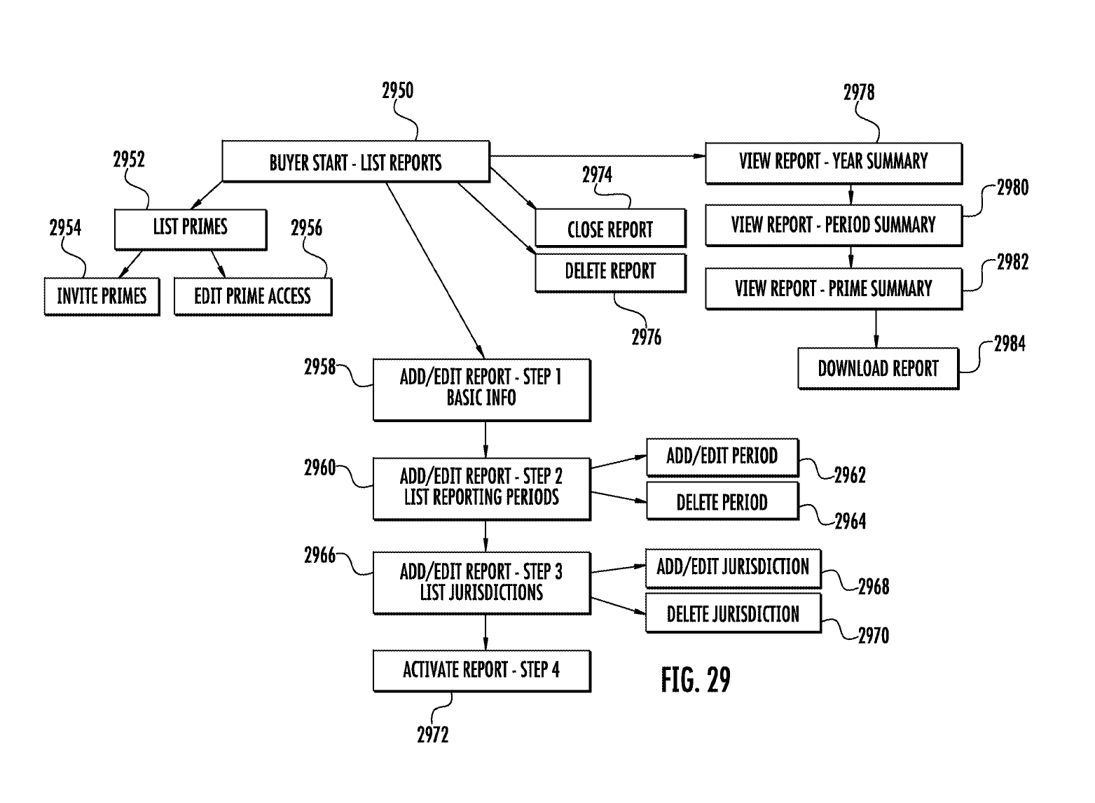

FIG. 29 depicts a flowchart for a buyer to create and view reports of tier-2 spending, according to one or more embodiments shown and described herein. As illustrated, the flowchart includes actions for inviting primes, creating reports, viewing reports, as well as adding and editing other information. Specifically, in block 2950 the buyer may begin. Along a first branch, the buyer may list primes to which he/she wants tier-2 reporting in block 2952. Options for inviting primes may be provided in block 2954 and options for editing prime access may be provided in block 2956.

Along a second branch, reports may be added and/or edited with basic info in block 2958. In block 2960, reports may be added and/or edited by listed reporting periods. In block 2962 the period may be added or edited. In block 2964, the selected period may be deleted. Additionally, in block 2966, jurisdictions may be added and/or edited. In block 2968 the options for adding and/or editing the jurisdiction may be provided, while in block 2970, the jurisdiction may be deleted. In block 2972, the report may be activated.

In a third and fourth branch, a report may be closed in block 2974 and a report may be deleted in block 2976. In a fifth branch, a year summary report may be viewed in block 2978. In block 2980, a period summary report may be provided. In block 2982 a prime summary report may be viewed. In block 2984, one or more of the reports can be downloaded.

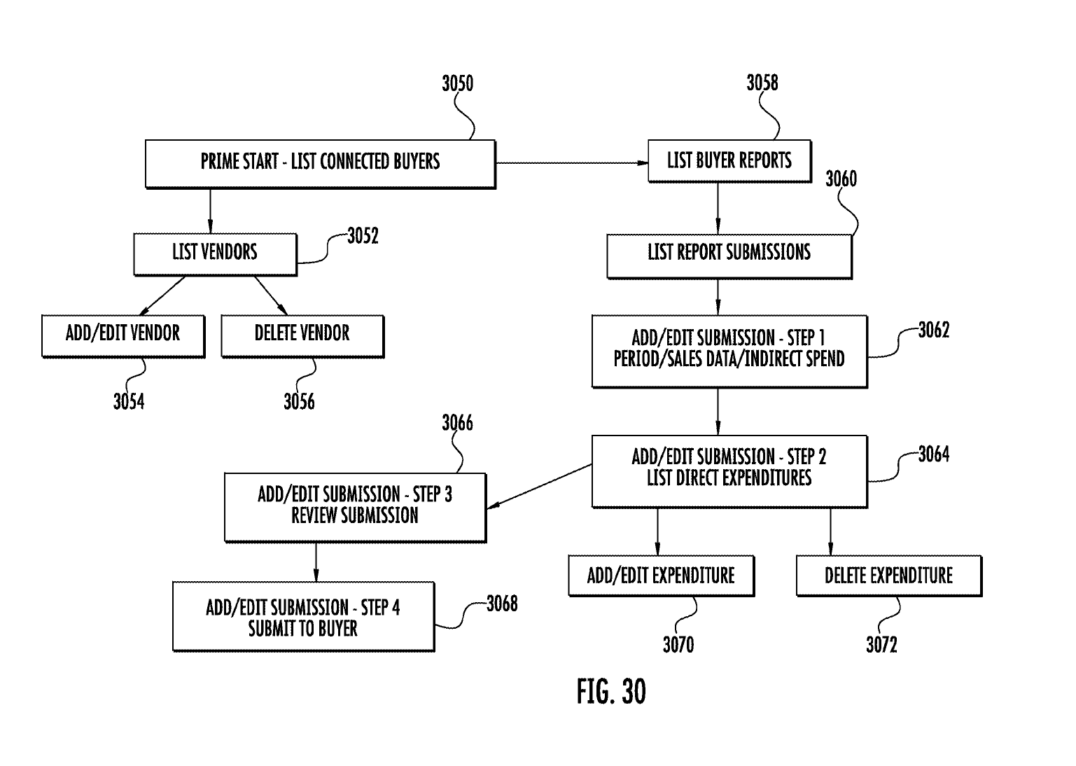

FIG. 30 depicts a flowchart for a prime to provide expenditures for tier-2 spending, according to one or more embodiments shown and described herein. As illustrated, the flowchart includes actions for including vendors, listing reports, listing expenditures, and providing other information. In block 3050 the prime may start and along a first branch, a list of vendors may be provided in block 3052. The list may be accompanied by options to add and/or edit a vendor in block 3054 and delete a vendor in block 3056.

Along a second branch, buyer reports may be listed in block 3058. In block 3060, a report of submissions may be provided. In block 3062 the submission may be edited with respect to period sales data and/or indirect spend. In block 3064, the submission may be added and/or edited with respect to direct expenditures. Accordingly, in block 3070 the expenditure may be added and/or edited. In block 3072 the expenditure may be deleted.

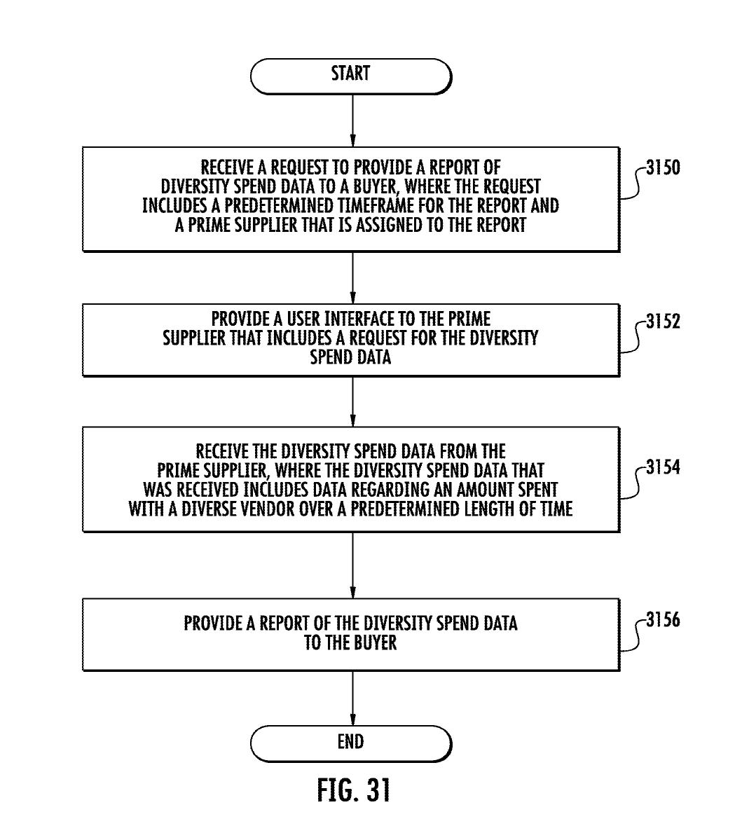

FIG. 31 depicts a flowchart for providing diversity data, according to embodiments disclosed herein. As illustrated in block 3150, a request may be received to provide a report of diversity spend data to a buyer, where the request includes a predetermined timeframe for the report and a prime supplier that is assigned to the report. In block 3152, a user interface may be provided to the prime supplier that includes a request for the diversity spend data. In block 3154, the diversity spend data may be received from the prime supplier, where the diversity spend data that was received includes data regarding an amount spent with a diverse vendor over a predetermined length of time. In block 3156, a report of the diversity spend data may be provided to the buyer.

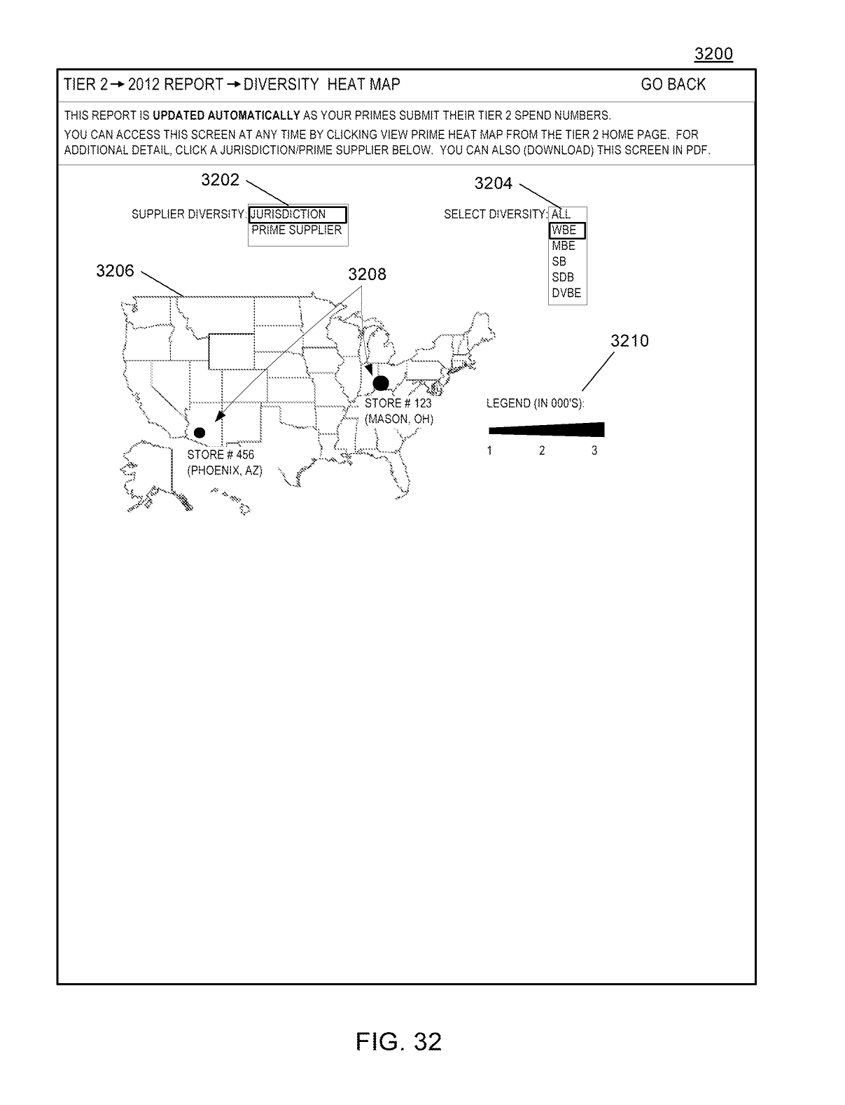

FIG. 32 depicts a user interface for presenting an example heat map 3200 of diversity spending, according to embodiments disclosed herein. In the heat map 3200, a supplier diversity selection drop down selection box 3202 allows a user to select whether to view the heat map 3200 based on the jurisdiction 3208 (for example, by store as illustrated) or by prime supplier (not illustrated). A diversity selection drop down selection box 3204 allows a user to select a particular type of diversity to display in the heat map 3200. For example, the user can select WBE to view only the jurisdictions or stores that use contractors that are Women Business Enterprises (WBE).

The heat map 3200 can use any suitable form of indicia to present the diversity spend data, including but not limited to size, shape, color, and density or contour lines, as would be understood by one familiar in the art. For example, the heat map 3200 can use size indicia to represent the relative amount of contribution to diversity spending that is attributable to each respective jurisdiction 3208 or store. For example, using the sample data of FIG. 17, the diversity spend data with Women Business Enterprises presented in the heat map 3200 includes diversity spend by Store #123 and Store #456. Store #123 is presented as a larger circle than Store #456 to reflect the greater amount of WBE diversity spend by Store #123. A legend 3210 can provide a correlation of the circle size to the diversity spend amount. The legend 3210 can be linear, logarithmic, or any other suitable scale as would be understood by one of ordinary skill in the art.

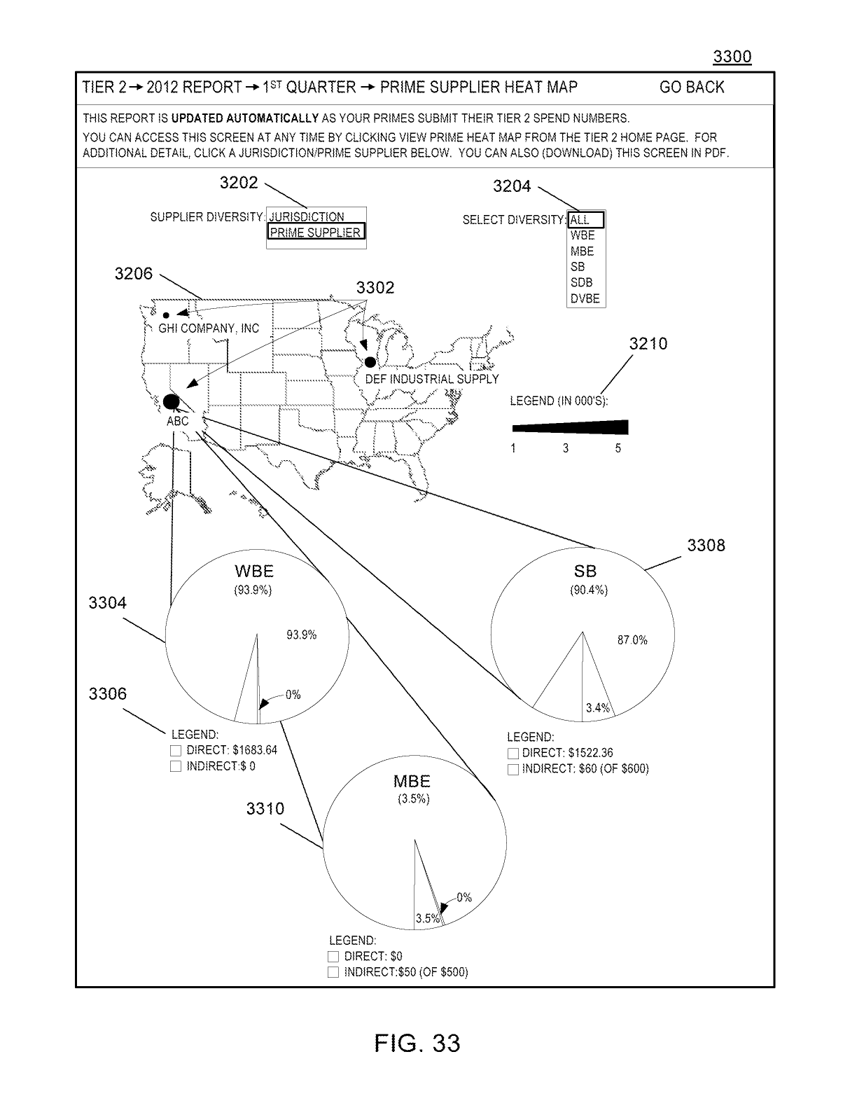

By presenting the diversity spend data in a heat map 3200 format, a user can advantageously determine visually which jurisdictions 3208 or stores are contributing to the diversity spend data for diversity classifications that are important to the buyer. This information can aid the buyer in making purchasing and other business decisions. For example, a buyer quickly see which jurisdictions 3208 are meeting the buyer's diversity spend requirements. In a configuration, the user can click on, or select, a jurisdiction 3208 or store to obtain additional information about the diversity spending of a store, for example to see the raw diversity spend data. In other configurations, additional visual data about diversity spend can be presented, for example using a format similar to that shown in FIG. 33 and the accompanying detailed description.

FIG. 33 depicts a user interface for presenting a second example heat map 3300 of diversity spending, according to embodiments disclosed herein. Similar to the heat map 3200 of FIG. 32, a supplier diversity selection 3202 allows a user to select whether to view the heat map 3300 based on the prime supplier 3302 (as illustrated) or by jurisdiction or store (not illustrated; see also FIG. 32). A diversity selection drop down selection box 3204 allows a user to select a particular type of diversity to display in the heat map 3200. For example, the user can select ALL to view the diversity spend data of the prime suppliers for all of the diversity classifications. In a configuration, the user can select a particular diversity classification to view only those prime suppliers that contribute to the diversity spend for the selected diversity classification (not illustrated).

The second example heat map 3300 can use any suitable form of indicia to present the diversity spend data, including but not limited to size, shape, color, and density or contour lines, as would be understood by one familiar in the art. For example, the heat map 3300 can use size indicia to represent the relative amount of contribution to diversity spending that is attributable to each prime supplier 3302. For example, using the sample data of FIG. 18, the diversity spend data presented in the heat map 3300 includes diversity spend data for the prime suppliers 3302 including ABC, DEF Industrial Supply, and GM Company, Inc. A legend 3210 can provide a correlation of the circle size to the diversity spend amount. The legend 3210 can be linear, logarithmic, or any other suitable scale as would be understood by one of ordinary skill in the art.

In a configuration, the user can click on, or select, a prime supplier 3302 to obtain additional information about the diversity spending of the selected prime supplier 3302. Any suitable information can be presented to the user. For example, the raw data can be presented, for example in a spreadsheet-style popup window (not shown).

In an embodiment, the diversity spend data can be processed to show the buyer useful information for making decisions. For example, a buyer may want to be presented with a visualization of the data that shows to what extent a particular prime supplier 3302 contributes to the buyer's diversity spend. As illustrated in FIG. 33, clicking on ABC can cause pie charts 3304, 3308, 3310 to be displayed for one or more diversity categories associated with ABC's diverse tier-2 suppliers. Referring now also to FIG. 18, if ABC company had $1683.64 in direct spend with WBE companies, $1522.36 in direct spend and $600 in indirect spend with SB companies, and $500 in indirect spend with MBE companies, then the pie charts 3304, 3308, 3310 illustrated in FIG. 33 can be displayed to the buyer. Pie chart 3304 illustrates that ABC contributed $1683.64 of the $1792.89, or 93.9% of the total diversity credit for the buyer (from FIG. 18) that is attributable diverse spending on WBE companies. Similarly, pie chart 3308 illustrates that between direct and indirect spend, ABC contributed 90.4% of the buyer's total diversity spend credit for the buyer. Whereas pie chart 3310 illustrates that ABC contributed only 3.5% towards the buyer's diversity spend on MBE companies.

By presenting the data visually, for example using pie charts 3304, 3308, 3310, a buyer can quickly determine that ABC is responsible for the majority of the buyer's diversity spend credit for WBE and SB companies. The buyer can use the information to assist in making strategic business decisions. For example, if the WBE and SB categories of diversity spend are particularly important to the buyer, the buyer may decide to diversify and use additional prime suppliers that use WBE or SB companies. By using additional prime suppliers, the buyer can avoid an unanticipated drop in diversity spend if ABC, or one of its tier-2 suppliers, were to be sold or acquired by another company and no longer meet the WBE or SB diversity requirements. Similarly, any diversity classification can be analyzed and the results illustrated to a buyer to assist in choosing prime suppliers 3302.

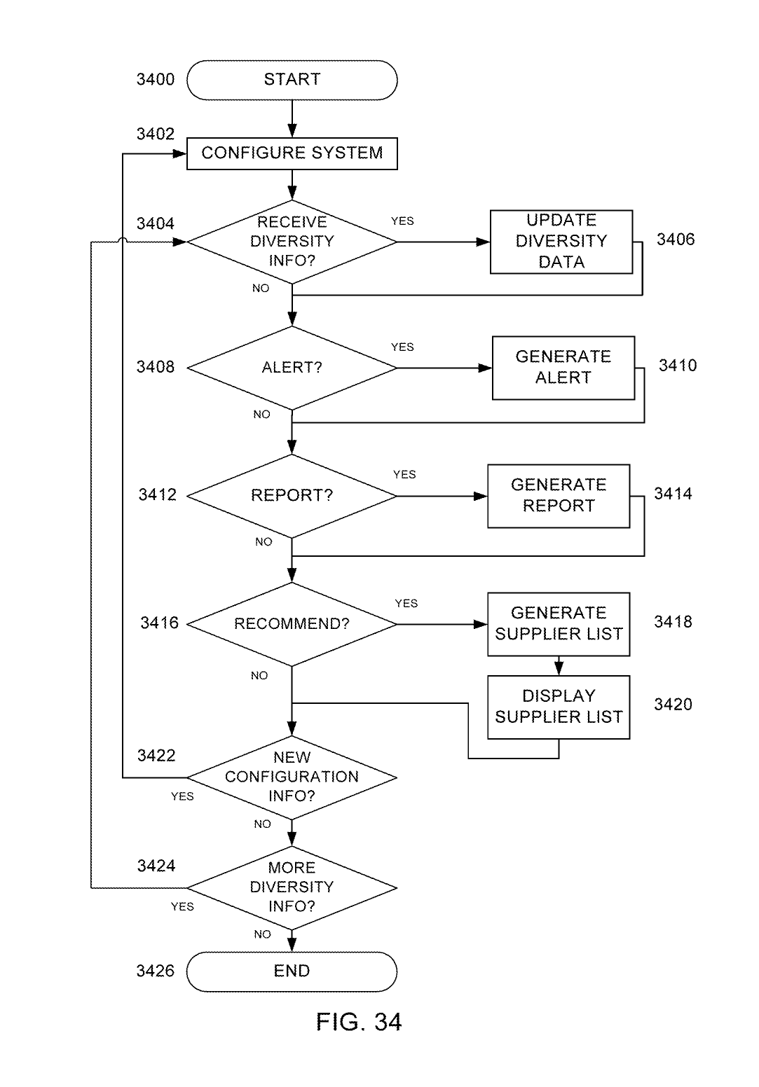

Referring now also to FIG. 34, a flowchart for providing diversity recommendations, diversity alerts, threshold reporting, and benchmarking is depicted, according to one or more embodiments shown and described herein. As illustrated the flowchart includes actions for generating alerts sent to a buyer, creating reports for a buyer upon receiving update diversity spend data from prime suppliers, and recommending prime suppliers for suppliers. The flowchart and processes described herein can supplement and operate in conjunction with other methods and processes described throughout this document.

In block 3400, labeled START, the process begins and continues to block 3402. In block 3402, the system can be configured, for example by retrieving configuration information from a file and/or configuration from a buyer. Example configuration information can include threshold diversity levels for generating alerts or reports, diversity requirement levels, and conditions for generating alerts or reports among other suitable configuration information. A threshold diversity level can be a static level, or can be based on a configurable rule or algorithm. For example, a threshold diversity level can be a time-based percentage of diversity credit for a particular diversity classification, or a particular dollar amount of diversity spend or an amount of diversity credit for a particular diversity classification. A diversity requirement level can be an annual or quarterly minimum acceptable level of diversity spend or diversity credit. A condition for generating an alert or report can be rule based, and can be triggered by events such as receiving data from a prime supplier, determining a change in prime supplier diversity, determining a decrease in a prime supplier diversity category, a threshold percentage change in diversity spend or diversity credit from a prime supplier, a specific period to generate a report such as quarterly or annually, and so forth. Processing continues to decision block 3404.

In decision block 3404, if the system receives new diversity spend data from a prime supplier, then processing continues to block 3406, otherwise processing continues to decision block 3408.

In block 3406, the diversity spend credits for the buyer can be updated with the diversity spend data received from the prime supplier. The system can execute algorithms to analyze the buyer's updated diversity spend credits and the received diversity spend data. For example, the system can execute algorithms to determine if threshold diversity levels, rules, or conditions in the configuration of block 3402 have been triggered, for example by crossing a threshold level. Processing continues to decision block 3408.

In decision block 3408, if a threshold or condition for generating an alert in in block 3406, the processing continues to block 3410, otherwise processing continues to decision block 3412.

In block 3410, an alert can be generated for the buyer. The alert can be any suitable form of alert, for example a message displayed on the system, a popup alert, an email alert sent to a designated email address, a text alert, and so forth. An example alert can indicate that a threshold or condition from block 3406 has been reached. Example alerts can include, but are not limited to, an alert that a prime supplier has submitted new diversity spend data, an alert that a prime supplier's diversity has changed from a previous reporting by a threshold percentage or amount, an alert that the buyer has achieved a threshold amount of diversity spend credit for a particular diversity classification, and an alert that the buyer either did not achieve, or is not projected to achieve, a required threshold diversity spend credit level, among other possible alerts. An example alert can be a message that a prime supplier previously reported diversity credits for direct or indirect spend with a tier-2 supplier that resulted in diversity spend credit for the buyer in the WBE classification, but has submitted new diversity spend data that does not include similar WBE diversity spend credit.

By generating an alert, the buyer can become aware of the change in diversity credit and take proactive steps to address the change. For example, the buyer can verify with the prime supplier whether there was mistake in reporting, whether the anticipated diversity spend data and credit will be present in a different reporting period, or whether the diversity of the prime supplier or one of its tier-2 suppliers has changed. The alert can be provided in real time, and separate from a report, in order to bring the details to the buyer's immediate attention. By providing a timely alert, the buyer can, in some instances, make changes to which prime suppliers it uses in order to achieve the desired or required diversity spend levels, or diversity spending among multiple suppliers, as will be explained in further detail with regard to blocks 3418 and 3420. Processing continues to decision block 3412.

In decision block 3412, if the conditions for generating a report are met, then processing continues to block 3414, otherwise processing continues to decision block 3416.

In block 3414, a diversity spend report can be generated, as described above. The diversity spend report can be triggered by any suitable criteria, for example based upon a period of time elapsing such as quarterly or annual reporting requirements, based on receiving diversity spend data from a prime supplier, or based on receiving periodic diversity spend data from all of a buyer's prime suppliers. The diversity spend report can be sent to the buyer using any suitable means, for example a display on the system, a retrievable PDF or portable document format document, an emailed document, and so forth. Processing continues to decision block 3416.

In decision block 3416, the system can determine prime suppliers for achieving desired or required diversity spend levels, in which case processing continues to block 3418, otherwise processing continues to decision block 3422. In various configurations, the buyer can request a list of prime suppliers, or the system can determine a list of prime suppliers based on a condition or rule being met in block 3406. For example, a buyer may desire to diversify prime suppliers in the event the buyer ascertains that the buyer's diversity credits for one or more diversity classifications are too dependent on a single prime supplier. In another example, the system can determine that the diversity spend credits from the buyer's existing prime suppliers are lower than required or lower than possible, and present a list of alternative or additional prime suppliers. In an embodiment, the system may receive diversity spend information for a prime supplier of another buyer and present that prime supplier as an alternative or supplemental prime supplier to the buyer.

In block 3418, the system can determine prime suppliers capable of being used by the buyer to achieve desirable or required diversity spend levels. The system can filter past and current diversity spend data of prime suppliers to determine a list of suppliers that would allow the buyer to achieve desired objectives, for example to attain required diversity spend levels for one or more diversity classifications, or to diversify spending among more suppliers to reduce the dependence on one or more diverse suppliers for attaining desired or required diversity spend levels The system can sort the list of prime suppliers by rank; the rank can be based on highest percentage of diversity spend for one or multiple diversity classifications in addition to any other suitable data for ranking as would be understood by one of ordinary skill in the art. In an embodiment, the system also can present prime suppliers to the buyer that might not allow the buyer to achieve the desired or required diversity spend levels. In that case, certain prime suppliers could be ranked lower or be presented with indicia indicating that the desired or required diversity could not be achieved using those prime suppliers. This can be particularly advantageous if no suitable prime suppliers are available, or to allow the buyer to diversify prime suppliers, or to allow the buyer to find a close match, or to present prime suppliers to the buyer that the buyer could then contact and engage for future business. In an embodiment, the system can determine a set of prime suppliers for achieving desired or required diversity spend levels for one or multiple diversity classifications. Processing continues to block 3420.

In block 3420, the buyer can be presented with a list of prime suppliers. As indicated in block 3418, the list of prime suppliers can be sorted. In an embodiment, the user can select a prime supplier and designate a particular spend amount with that prime supplier, whereupon the list can be resorted and updated to indicate which remaining prime suppliers can be used to achieve the desired or required diversity spend levels. In this way, a user can dynamically adjust which prime suppliers are selected and the spend levels with each prime supplier until the user achieves the necessary diversity spend credits for each diversity classification that is desired by the buyer. Processing continues to decision block 3422.

In decision block 3422, if the user wants to make any configuration changes, such as changing the set of prime suppliers selected in block 3420, then processing continues back to block 3402, otherwise processing continues to decision block 3424.

In decision block 3424, if there is additional diversity data from prime suppliers, then processing continues back to decision block 3404, otherwise processing terminates at end block 3426 labeled END.

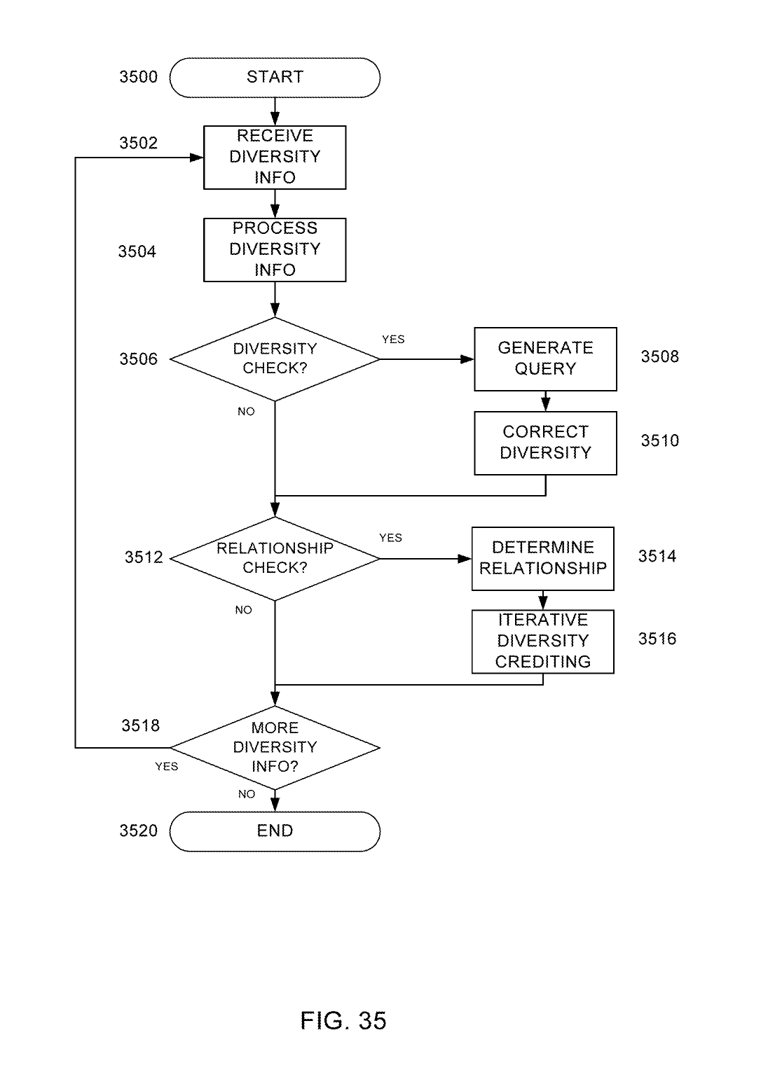

Referring now to FIG. 35, a flowchart for providing diversity crediting is depicted, according to one or more embodiments shown and described herein. As illustrated, the flowchart includes actions for processing buyer and supplier data to determine the accuracy of diversity reporting, to determine multiple tier buyer-supplier relationships, and/or to determine diversity crediting. The flowchart and processes described herein can supplement and operate in conjunction with other methods and processes described throughout this document.

In block 3500, labeled START, the process begins and continues to block 3502. In block 3502, the system receives diversity spend data from a party, such as a prime supplier. In various configurations, the party can be a buyer, a prime supplier, a tier-2 supplier, a contractor, and so forth. The diversity spend data can include diversity spend data as well as information that identifies the parties. For example, the diversity spend data can identify the prime supplier for a buyer as well as the identities of each contractor of the prime supplier, and the direct and indirect spend data credited to the buyer as described above.

In block 3504, the system can aggregate the diversity spend data for each party and process the information to perform diversity error checking and determine if multiple levels of buyer-seller relationships exist between the various parties. As diversity spend data is received for each party in block 3502, the system can process the information received and compare it with previously obtained diversity spend data and the identities of the reporting parties.

In decision block 3506, if two or more buyers requested diversity spend data from the same prime supplier, and the prime supplier provided inconsistent diversity spend data to a buyer that was not consistent with the diversity spend data provided to the other buyer, then in block 3508, the system could generate a query to either buyer or to the prime supplier to determine whether there was an error in the reporting of the diversity spend data. For example, if the prime supplier indicated indirect spend credit for services of a WBE company to the first buyer, but to the second buyer the prime supplier reported indirect spend credit for services of a company that was both a WBE company and a SBE company, a query could be generated to determine if the prime supplier also should have reported SBE indirect spend credit to the first buyer as well. The system can determine other inconsistencies or errors as would be understood by one of ordinary skill in the art. In block 3510, the diversity spend data can be corrected, for example by the prime supplier resubmitting or correcting the diversity spend data. The error checking, querying, and correcting of reported diversity spend data can be performed for buyers, prime suppliers, subcontractors of the prime suppliers, and any suppliers or contractors in the supply chain.

The system can also determine the buyer, supplier, and contractor relationship for each party. Although the relationship between a buyer and a prime supplier, and between a prime supplier and a subcontractor can be fairly straightforward, many companies have complex and interconnected relationship with one another. It is possible for one company to be a prime supplier to a first buyer, and a subcontractor to a prime supplier of a second buyer. Similarly, companies can purchase goods and services from one party and sell goods and services to another party. Each of those parties can be a buyer, a seller, or a subcontractor depending on the context of the exchange. This can create a complex web of commercial interactions between parties.

In decision block 3512, if a company is a buyer, seller, or subcontractor depending upon whether it the commercial relationship is with a first party or second party, then in block 3514 the system can analyze received diversity spend data for each buyer, prime supplier, subcontractor of a prime supplier, and any supplier or contractor in the supply chain. For each party in the supply chain, the system can apportion pro-rata diversity spend credit in an iterative fashion. For example, if a company is a buyer that receives diversity credit from direct spend with a diverse supplier for goods or services, and that same company is a non-diverse supplier of goods and services to a second buyer, then that company may receive direct spend credit for expenditures with the supplier, and may report an indirect diversity spend credit to the second buyer. If a third buyer purchases goods and services from the second buyer, then the third party may in turn receive a fractional pro-rata amount of the diversity spend credit from the second buyer, assuming that the goods or service purchased from the second buyer can be attributable back through the supply chain to the original diverse supplier. Each party in the chain can advantageously receive fractional pro-rata amounts of diversity spend credit attributable to goods or services in the supply chain originating from a diverse supplier or contractor.

Therefore, the diversity credit attributable to the contributions of each diverse party in a supply chain can be aggregated and credited to each subsequent party in the supply chain. The system can provide iterative diversity crediting in real time throughout the supply chain as the sale of goods and services are reported by diverse suppliers and contractors. This method provides an advantage over other methods of diversity reporting because the iterative diversity crediting more accurately reflects the buyer's total contribution towards spending with diverse companies. Even though a diverse supplier may not contract directly or even indirectly with a particular buyer, that buyer's diversity spend requirements can encourage another party in the supply chain to select a diverse supplier. Therefore, a diverse supplier may receive a contract even when that diverse supplier may be two or more parties (or levels) distant from the buyer in the supply chain. Iterative diversity credit reporting therefore advantageously helps diverse companies receive contracts for goods and services.

In decision block 3518, if there is additional diversity spend data being reported and collected, then processing returns to block 3502 to receive the diversity spend data and execute additional operations. If there is no additional diversity spend data, then processing terminates and end block 3520 labeled END.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g., RAM or ROM) via one or more data buses. The data buses can carry electrical signals between the processor(s) and the memory. The processor and the memory can comprise electrical circuits that conduct electrical current. Charge states of various components of the circuits, such as solid state transistors of the processor(s) and/or memory circuit(s), can change during operation of the circuits.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A method of determining diversity spend credit for parties in a supply chain, comprising:
receiving diversity spend data for a plurality of parties in a supply chain, wherein at least one party in the supply chain is a diverse supplier of a good or service; and
iteratively determining, for each party in the supply chain, diversity spend credit to the party for the purchase of a good or service from another party in the supply chain, where the diversity spend credit is directly or indirectly attributable through the supply chain to the purchase of the good or service from the diverse supplier.

2. The method of claim 1, wherein each party in the supply chain receives diversity spend credit in approximately real time as diversity spend data is received from the parties in the supply chain.

3. The method of claim 1, wherein the supply chain includes at least three parties including the diverse supplier, a prime supplier that purchases the good or service from the diverse supplier, and a buyer that purchases a good or service from the prime supplier.

4. The method of claim 1, wherein the supply chain includes at least four parties including the diverse supplier, a first buyer of a good or service from the diverse supplier, a second buyer of a good or service from the first buyer, and a third buyer of a good or service from the second buyer.

5. The method of claim 1, wherein the diverse supplier meets the criteria of one or more of the following diversity categories: a women's business enterprise (WBE), a minority business enterprise (MBE), a small business (SB), a small disadvantaged business (SDB), and a disabled veteran business enterprise (DVBE).

6. The method of claim 1, wherein the first party of the supply chain is a buyer, and further comprising:
aggregating, for the buyer, diversity spend credits for each of a plurality of supply chains to determine diversity spend data for the buyer.

7. The method of claim 6, wherein each of the plurality of supply chains begins with a diverse supplier and includes a unique set of intermediary parties.

8. The method of claim 1, further comprising:
generating an alert, for the buyer, if upon iteratively determining the diversity spend credit for the buyer, the diversity spend credit associated with a diversity category crosses a threshold level.

9. The method of claim 8, further comprising:
generating, for the buyer, a list of one or more alternative suppliers,
wherein the list of alternative suppliers can be ordered based on one or more of the following objectives:
(i) increase the diversity spend credit associated with the diversity category above the threshold level, or
(ii) diversify the diversity spend credit associated with the diversity category among multiple suppliers.

10. A method of error checking diversity spend data of a supplier of a good or service, comprising:
receiving, for a first buyer, a first set of diversity spend data from the supplier;
receiving, for a second buyer, a second set of diversity spend data from the supplier;
comparing at least a portion of the first set of diversity spend data to at least a portion of the second set of diversity spend data;
determining, as a result of the comparing operation, an inconsistency between the first set of diversity spend data and the second set of diversity spend data.

11. The method of claim 10, further comprising:
querying one or more of the first buyer, the second buyer, or the supplier regarding the inconsistency; and
receiving corrected diversity spend data from one or more of the first buyer, the second buyer, or the supplier.

12. A diversity reporting system, comprising:
one or more processors configured to:
receive diversity spend data from one or more suppliers,
process the diversity spend data to determine, for a buyer, a diversity spend credit in each of one or more diversity categories, based at least in part on the amount spent by the buyer with each of the one or more suppliers, and where the diversity spend credit is further apportioned between one or more of:
(i) a plurality of jurisdictions or stores of the buyer that purchased a good or service from one or more of the suppliers, or
(ii) each of the one or more suppliers, and
generate a heat map based on:
(i) one or more selected diversity categories,
(ii) a geographic location of a jurisdiction, store, or supplier, and
(iii) the amount of apportioned diversity spend credit for the jurisdiction, store, or supplier.

13. The system of claim 12, further comprising:
a display configured to present the heat map.

14. The system of claim 12, wherein the at least one diversity category is selected from the group consisting of a women's business enterprise (WBE), a minority business enterprise (MBE), a small business (SB), a small disadvantaged business (SDB), and a disabled veteran business enterprise (DVBE).

15. A non-transitory computer readable medium having instructions stored thereon that when executed by one or more processors causes the processors to:
receive diversity spend data for a plurality of parties in a supply chain, wherein at least one party in the supply chain is a diverse supplier of a good or service; and
determining, for each party in the supply chain, diversity spend credit to the party for the purchase of a good or service from another party in the supply chain, where the diversity spend credit is directly or indirectly attributable through the supply chain to the purchase of the good or service from the diverse supplier

16. The method of claim 1, wherein the diversity spend credit for each party is updated and aggregated in approximately real time as diversity spend data is received from the parties in the supply chain.

17. The method of claim 1, wherein the diverse supplier meets the criteria of one or more of the following diversity categories: a women's business enterprise (WBE), a minority business enterprise (MBE), a small business (SB), a small disadvantaged business (SDB), and a disabled veteran business enterprise (DVBE).

18. The method of claim 15, wherein when the diversity spend data of the buyer crosses a threshold level the instructions further cause the processors to:
generate one or more of
an alert, or
a diversity spend report, and
send, to the buyer, one or more of
the alert, and
the diversity spend report.

19. The method of claim 18, wherein the instructions further cause the processors to:
generate a list of one or more alternative suppliers,
wherein the list of alternative suppliers can be ordered based on one or more of the following objectives:
(i) increase the diversity spend credit above the threshold level, or
(ii) diversify the diversity spend credit among multiple suppliers.

20. The method of claim 18, wherein the diversity spend data includes a diversity category and wherein the threshold level is associated with a selected diversity category.
